(19) United States
(12) Patent Application Publication
(10) Pub. No.: US 2004/0181811 A1
(43) Pub. Date: Sep. 16, 2004

(54) Thin DOCSIS in-band management for interactive HFC service delivery

(76) Inventor: Selim Shlomo Rakib, Cupertino, CA (US)

Correspondence Address: RONALD CRAIG FISH, RONALD CRAIG FISH, A LAW CORPORATION, POST OFFICE BOX 2258, MORGAN HILL, CA, 95038, US

(21) Appl. No.: 10/389,728

(22) Filed: Mar. 13, 2003

(51) Int. Cl. H04N 7/16; H04N 7/173

(52) U.S. Cl. 725/122; 725/132; 725/140; 725/111

(57) ABSTRACT

Circuitry and processed carried out thereby are disclosed for transmitting video-on-demand and interactive service data and other service data on an MPEG multiplex and sending management and control data including conditional access EMM key data in-band in said MPEG multiplex in MPEG packets having the DOCSIS PID. Processes to send conditional access data by sending ECM messages containing control words encrypted with session keys in said MPEG multiplex and sending EMM messages containing session keys encrypted with private set top box users keys are disclosed. The EMM messages are sent in-band in MPEG packets having the DOCSIS PID to only the set top boxes that request them and which have ordered an encrypted service. A head end with routing/switching capability to route MPEG transport streams encapsulated in IP packets is also disclosed.

### BACKGROUND OF THE INVENTION

The invention pertains to use of a DOCSIS in-band management channel for management of broadband services delivery such as video-on-demand over cable television Hybrid Fiber Coaxial (HFC) cable systems and the resulting simplification of set top adapters for receiving digital television transmissions.

Video services such as video-on-demand (VOD) has been delivered in the prior art over HFC systems. The treatise Michael Adams, “Open Cable Architecture” (2000 Cisco Press) ISBN 1-57870-135-X, the entirety of which is hereby incorporated by reference, describes the state of the prior art of digital cable television. Chapter 4, pp. 49-84 describes digital television technologies for compression of video, audio, data and system information and baseband and broadband transmission mechanisms. Chapter 5 describes adding digital television services to cable systems, and out-of-band data communications for management. Chapter 6 describes the conventional digital set top converters for digital television. Chapters 8 and 10 describes interactive and on-demand services such as movies and music on demand, post broadcast on demand, distance learning and other services. Chapter 9 and 11 describes case studies in interactive and on demand cable systems.

Interactive services provide extensions to the cable system to provide a new class of services such as home shopping, home banking, e-mail, web access, gaming, stock tickers, all of which were previously supplied by connections to the internet through ISPs and dial up, ISDN, DirecPC, etc.

Several prior art attempts to deliver interactive services over HFC have been implemented in field trials. Both used an out-of-band channel for transmission of software downloads and management and control data between the client set top decoders and the servers at the head end. The Time Warner Full Service Network (FSN) started in February 1993 to deliver VOD, sports on demand, news on demand as well as interactive video games, home shopping, long distance access, voice and video telephone and personal communication services and Web browsing as well as traditional analog CATV services. Eight media servers were connected to disk vaults via SCSI-2 interfaces. The disk vaults provided enough storage for about 500 movies. For the forward path, the media servers were connected to and ATM switch via a SONET OC3 connection. A total of 48 OC3 connections provided for 5,184 Mbps of usable payload bandwidth after SONET and ATM overhead were subtracted. The ATM switch was connected to a bank of 64-QAM modulators. 152 DS3 links provided 5,600 Mbps of payload capacity from the ATM switch to the neighborhoods after overhead. The QAM modulator outputs are tuned in the frequency range from 500 to 735 MHz with the forward digital channels spaced at 6 MHz. The 6 MHz analog CATV channels occupied the spectrum from 50 to 500 MHz. The combined RF signal from 50 to 735 MHz was used to modulate a laser which drove a single mode fiber which took the signal out to the neighborhood about 10 miles away. At the neighborhood, the optical signal was converted back to RF in the optical node and used to feed a coaxial cable network which passed about 500 subscribers. The RF signal fed the home communications terminal or digital set top converter (HCT) in each home. The HCT was a powerful RISC based multimedia computing engine with video and audio decompression and extensive graphics capability. The HCT also included an analog set top converter for the CATV analog signals. An ATM addressing scheme allowed data to be addressed to any HCT.

The upstream path was a QPSK modulated signal transmitted by each HCT in the 900 to 1 GHz frequency band with carriers at 2.3 MHz spacing, each channel having a 1.152 Mbps data rate after ATM overhead. Each upstream channel was time division multiplexed so multiple HCTs could share the same channel with bandwidth awarded by the headend in downstream messages on a forward channel so that only one HCT was enabled to transmit during any given time slot. By default, each HCM had access to a 46 Kbps constant bit rate (CBR) ATM connection. The upstream RF is converted to optical signal at the optical node and separate optical fibers are used to carry the upstream and downstream. At the headend, the optical signal is converted back to RF and then fed to a bank of QPSK demodulators which convert the ATM cell stream to ATM format T1 link. The outputs of the demodulators is combined by an ATM demultiplexer which does traffic aggregation and conversion from DS1 to DS3 rates and outputs ATM format DS3 streams o the ATM switch which passes the data to the media servers. An ATM addressing scheme allows any HCT to send to any server.

The connection manager was a distributed set of processes which run on the media servers. In response to an application request for a connection with a given quality of service, the connection manager determines a route, allocates connection identifiers and reserves link bandwidth. The connection identifiers are passed to the media server and HCT via the out-of-band channel it is believed by the applicants. On demand services use the connection manager to establish a constant bit rate ATM connection for each media stream from a server to the HCT. This constant bit rate stream is required to guarantee quality of service of the connection so the cell loss rate is less than a predetermined figure of merit needed to transmit high quality MPEG compressed video streams. The use of a connection for each application request would quickly overload the system with excessive overhead it was found however for the distributed application environment, so connections were reserved for only on-demand services and all other communication sessions such as IP networking traffic were relegated to connectionless networks.

Each HCT was given three IP addresses at boot time: a fast IP address for a fixed 8 Mbps connection in each forward application channel; a slow IP address for a netword using a fixed 0.714 mbps connection in each forward application channel; and a control IP using a forward QPSK channel with a 1 Mbps capacity. The fast IP network was used for application downloads initiated by file transfer requests from the HCT. Application programs were compressed. The slow IP network was used for general communications between the client and server parts of a distributed application. The HCT could send and receive on this slow IP network while the application was executing.

The slow IP network supported the distributed computing model by carrying communications that allows a client application in an HCT to invoke a remote procedure call over the slow IP network to cause a process in the server at the head end to run. This simplified the development of distributed applications. The HCT had considerable resources and performed the lion's share of processing and were considered thick clients since the HCTs were responsible for the presentation layer functions without any help from the headend servers. Much less communication between server and client HCT is required by this model since the server was just mainly retrieving data objects such as a text string for sending to the HCT, and the thick client HCTs then would do all the processing to present it as an animated object overlay. This required much less communication that a thin client HCT where the server would send an animated overlay for display by the HCT client. Because of the thick clients, the servers could be designed to support many client instances without having to maintain a separate context for each one. Thus, thin clients were discouraged in this network because of the excessive demands on the network for communications on the slow IP network.

Interactive services provided by the Time Warner Full Service Network (hereafter FSN) included navigation, games, home shopping and video-on-demand. Navigation services included analog tuning, interactive program guide that allows customer to scroll through a grid of time vs channel, parental controls, subscriber preferences and configuration.

The FSN applications to implement interactive services required significant network resources in each area of interactive service. Software downloads to the HCT to load the application needed to implement whatever interactive service a user requested through the HCT remote control such as selecting a channel to view, responding to an on-screen dialog. All FSN applications require two-way communication with the head end with varying quality of service requirements. For example, navigation and home shopping use best efforts in most cases, but streaming video or audio was requested, guaranteed quality of service was required to implement it.

The control IP network was mapped onto a 1 mbps ATM connection on each forward control channel (out-of-band), and was used for general control signaling to all HCT in a neighborhood. Thus, significantly to the cost and complexity of the system, multiple out-of-band forward control channels were used for overhead management and control traffic on the control IP network.

It was found that the distributed applications using connectionless networks had a need for connectionless overhead signalling traffic because of the use of multiple short bursts, and it was found that the IP network protocol provided a useful way to do this signaling. The protocol stack for this prior art system is shown in FIG. 1. The connectionless communication protocols that support the distributed applications environment of the interactive services are on the left of the diagram, and the connection oriented protocols that support the on demand streaming video and audio services are on the right of the diagram. It was found in the FSN that interactive service require a different communication model than on-demand services because interactive services were bursty and best supported by an IP network whereas on-demand video and other streaming media required a continuous stream of data that was best provided by a connection oriented network such as that provided by ATM.

Although the FSN HCTs were expensive, highly capable machines with 100 MIPs capacity, the demands of being a thick client brought them to their knees so to speak. Real time composing of live video and graphics in software put a tremendous load on the CPU. At 60 fields per second, the CPU had just 16 milliseconds to render graphics before the field is displayed, and the field cannot be late. Even though audio and video decompression was done in hardware, a faster 140 MIPs version of the HCT was soon required to support FSN applications.

Another drawback of the FSN network was found to be massive waste of upstream bandwidth caused by the headend allocated TDMA scheme. This is because it used a fixed bit rate allocation to each HCT, and the allocation was wasted most of the time. As a result, the DAVIC out-of-band (OOB) protocol was developed to include a reservation protocol that allows many more HCTs to share a given out-of-band return channel. Sharing of the out-of-band return channel however required a separate media access control (MAC) protocol similar to that used by the shared media to regulate upstream transmissions by the HCTs. The MAC protocol most often used for the OOB return channel is similar to the Ethernet Collision Sense protocol. The out-of-band channels required at least separate tuner and software to implement the MAC protocol thereby further increasing the expense of each HCT.

A direct descendant of FSN was the Pegasus system which started in 1995. At that time, the major stumbling block to success was the cost of the interactive set top receiver/decoder which tuned to the carrier carrying the digital data and demodulated, decoded, decrypted, decompressed and encoded the decompressed data into a suitable television signal, hereafter referred to in all its different species as the set top box. The Pegasus Orlando deployment had only 4000 set top boxes, so the cost was manageable, but nationwide deployment interactive and on demand services was an entirely different story in terms of the cost of set top boxes (STB) so STB cost became the critical factor in the design of Pegasus. Pegasus adopted a Trojan Horse strategy in an attempt to reduce the STB cost. The idea was to include interactive feature support in the STB at a small incremental cost over the circuitry required for the broadcast processing, but these circuits and applications appear only when interactive services are developed and delivered by the cable operator.

The Pegsus network uses a real time, two-way network that linked the STBs to the headend to support interactive services. This two way network was based upon standard networking protocols and equipment but was designed for low service penetration. All the same interactive services were provided as FSN but at a much lower cost. Lowering the cost was enabled by:

(1) using data carousels wherever possible to reduce transactional and network traffic required to download interactive applications;

(2) the DAVIC OOB protocol definition was used to support sharing of the return oout-of-band channel by many more bursty traffic sources (this reduced the number of QPSK demodulators per distribution hub by a factor of 15 compared to FSN);

(3) the operating system and navigation software are always resident in the Pegasus STB thereby greatly reducing the network resources consumed by software download but increasing the cost of the STB; and

(4) the use of MPEG-2 transport to deliver both digital broadcast as well as interactive services.

Pegasus 2 was the first network to use MPEG-2 transport to deliver interactive multimedia over a switched network. MPEG-2 transport is more efficient than other transport protocols such as ATM and IP, and MPEG-2 transport includes support for synchronization, statistical multiplexing and conditional access functions. MPEG-2 transport provides an integrated transport solution for both broadcast and on-demand services and provide the advantages of low overhead and it is designed for one way services such as video-on-demand. Apparently, the out-of-band channel was used for upstream communications indicating the desired video program. Another advantage of MPEG-2 transport is the STB is capable of both broadcast and on demand services, and MPEG-2 supports data as well as video and audio encapsulation using the private data section mapping. Pegasus showed us that MPEG-2 was an ideal solution for integrated delivery of digital broadcast and on demand services. Compare this to FSN which used an ATM-to-the-home switchng network to provide both interactive and on-demand services including VOD but at a high cost for the thick client STB. The FSN used ATM both for its switching and transport protocol needs. ATM is very inefficient for unidirectional traffic. It was found to be wasteful of upstream bandwidth because of the asymmetric traffic pattern generated by on demand services and it was wasteful of capacity of ATM equipment which was designed for bidirectional operation and not the asymmetric traffic of VOD and other on demand services. ATM overhead is about 12% (mainly caused by the 5 byte ATM header in every cell). There was additional cost in the headend and every STB to provide ATM adaptation circuitry and software in FSN which made the system more expensive and difficult to justify for nationwide deployment with millions of STBs. This extra circuitry was necessary because digital broadcast technologies are all based on MPEG-2 transport protocol so every digital broadcast service in FSN had to be adapted to ATM at the headend or every STB had to support both ATM and MPEG-2 transport protocols.

The FSN delivered MPEG-2 streams over an ATM infrastructure. FIG. 4 shows the communication protocol stack used to do this. The bottom frequency division multiplexing layer (FDM) divided the broadband spectrum into a number of channels. NTSC channels carried analog broadcast, QAM channels carreid digital services such as digital broadcast and interactive and on demand services, and QPSK channels carried signalling and control traffic. For the QAM channels to carry MPEG audio and video, an adaptation layer was required to provide error-correction and framing functions. This layer packed ATM cells into a framing structure so the STB could recognize the individual cells in the QAM bit pipe. An AAL-5 adaptation layer provided the functionality to allow large blocks of MPEG data to be segmented into ATM cells for delivery through the ATM switching network. At the STB, AAL-5 was used to reassemble the MPEG packets for decoding into video and audio.

In FSN, TCP/IP data had IP data blocks segmented using AAL-5 into ATM cells, and the IP data blocks were reassembled at the STB using AAL-5. The STB distinguished between audio, video and data by the Virtual Channel Identifier (VCI) carried in the header of every ATM cell. This allowed the STB (HFC) to simultaneously receive audio, video, and data streams over a QAM channel without confusion.

In the FSN, MPEG data delivery to the STB via ATM cells and infrastructure had to be managed to ensure that the customer saw a smooth, high quality video with correctly synchronized audio. To do this, the MPEG data was stored on a disk storage system and fetched in large blocks. The MPEG data was then segmented using AAL-5 into ATM cells which were transmitted at a constant rate to ensure that the STB did not get overrun and drop cells causing video quality to suffer. The STB filtered ATM cells based on their VCI and selected only cells for the chosen video flow and reassembled the MPEG packets from the chosen ATM cells using AAL-5. An MPEG decoder then reconstructed the original video signal from the MPEG packets. Video signals are extremely time-sensitive, and delivery of the MPEG data had to be at exactly the same rate as the MPEG decoding. In analog video delivery, the horizontal and vertical synchronization pulses synchronized the TV display, but there is no such mechanism in ATM networks because they are switched and use multiple, asynchronous physical links to deliver the cells. This problem was solved in FSN by sending ATM timestamps from a master clock at the server. The server clock ensured that the disk reads and the ATM card writes happen at the correct time to ensure MPEG data is played out of the server and transmitted on the network at the correct rate. At the STB, timestamps from the server clock are received frequently. The STB has its own clock which is driven by an accurate voltage controlled crystal oscillator (VCXO). The timestamps were used to adjust the frequency of the VCXO to keep the STB clock synchronized with the server clock. An MPEG buffer holding MPEG data for the MPEG decoder in the STB had to be carefully managed to prevent overflow and underflow.

The Pegasus-2 system, in contrast to FSN, added incremental on demand services to an existing digital broadcast network that supported real-time, two-way signaling. Significant transport cost reductions were achieved by using MPEG-2 transport from server to STB and eliminating the ATM infrastructure of FSN. MPEG-2 transport is more efficient than IP or ATM transport and MPEG-2 transport includes support for synchronization, statistical multiplexing and conditional access functions.

However, use of MPEG-2 transport also caused problems peculiar to the use of MPEG-2 transport streams. MPEG-2 transport was not designed for the high speed data transport needed for the high speed data such as broadband internet access which was provided over and above streaming video and audio in on demand services. However, this problem was solved by mapping the high speed data into the private data sections of MPEG-2 transport streams. Another stroke of luck for Pegasus was that the DSM-CC data carousel specification included an efficient segmentation function for mapping large data carousel packets into MPEG-2 transport packets.

MPEG-2 was also not designed as a wide area network protocol since it does not include any connection managment protocols or any connectionless routing mechanisms. Therefore, adapting MPEG-2 to a switched network was challenging for the Pegasus designers. This problem was overcome in the Pegasus prior art by design of the complex QAM switching matrix to implement an MPEG-2 transport switch, as shown in FIG. 3. Each media service was coupled to a row of QAM modulators by an MPEG-2 native (no protocol translation needed) DVB asynchronous serial interface whcih could saturate up to 5 256-QAM channels. Each set top group shared a bank of on-demand channels which contained 6-8 QAM channels. If a media server failed, the customer would lose service but could reorder the service and be coupled through the QAM switching matrix to another media server.

The QAM switching matrix provided only limited switching because the dimensions of the switch matrix were determined by M, the number of on demand channels in the bank, multiplied by N, the number of QAM modulator per media server, multiplied by the number of streams in an on demand channel (6-8).

Another problem with the Pegasus MPEG-2 transport mechanism is that it assumes a constant delay network because it was designed for broadcast and not switching networks.

FIG. 2 is a diagram of the channel types in the Pegasus system. Note that the Pegasus 2 system uses out-of-band channels just like the FSN.

Digicable is another prior art system supplied by General Instrument for end-to-end satellite and cable system distribution networks. It too used an out-of-band data channel to deliver common system information associated with all in-band channels. Out-of-band traffic in these prior art systems included: Entitlement Management Messages (EMM) addressed to individual STBs and carrying conditional access secure authorization instructions for requested services; Service Information that supports the STB navigation application with information about the requested service; program guide information to display what is on the various channels at various times; an Emergency Alert System messages to cause the STB to display a text message, play an audio message or force tuning to an alert channel.

Major Problems with the Prior Art

At least two major problems exist in the FSN and Pegasus prior art. Software download to the set top has several advantages, but it also has several significant disadvantages. A major advantage of software download to the STBs is that it simplifies the hardware and software of the STB because the STB does not need to have sufficient memory to store all the needed applications. Memory is expensive, so this advantage makes each STB less expensive to build. This is a significant advantage since millions of STBs need to be built for nationwide deployment of interactive and on demand services. Another major advantage of software download is that new applications for new services can be added at the head end and propagated to any STB over the HFC thereby making the STB future proof. Further, application bugs can be fixed and updated at will without rendering all the STBs obsolete.

A significant disadvantage is that software download increases greatly the amount of upstream network traffic from the STB to the server telling the server what application software to download each time the user presses a button to change the channel or invoke any other service. With thousands of STB and with an out-of-band channel carrying this upstream traffic with limited bandwidth, many problems are caused. Among them are contentions and delays for the available bandwidth and the complications and expense of a separate media access control protocol and separate tuner just for the OOB channel to carry management traffic.

Another significant disadvantage of software download is that it takes time to download the application software. Small applications can be downloaded over a high speed channel in a fraction of a second, but downloading a large application introduces delays and consumes large amounts of network capacity. Also, if a download server or channel is unavailable, the customer will see a loss of service. Making the navigator application resident on the STB reduces this problem but makes the STB more expensive.

Several mechanisms have been used in the prior art for software download. The first is a data carousel wherein software applications and data such as program guide data are continuously transmitted as a set of files over a QAM channel. The STB then just picks the necessary application and data files out of the stream. This causes delays in waiting for the right files and consumes network downstream bandwidth unnecessarily when the need by STBs for files is light. An MPEG-2 transport stream private data portion can also be used for application and data download by placing the application or data in a separate program elementary stream (PES). When the STB selects an MPEG-2 program, the STB activates a loader application which listens to the PES and recovers the data. As the application programs are received, the loader program places them in memory and launches them. Also, an out-of-band channel providing point-to-point service between the server and the STB can also be used, but this requires the STB to have a separate tuner and MAC protocol just for the OOB channel thereby making the STB more expensive. Further, the OOB downstream channel can easily become overwhelmed by the software download traffic if used to download applications for all the interactive and on demand services.

Another major problem with all the FSN, Pegasus and Digicable prior art systems was the use of out-of-band channels to communicate system information. As mentioned previously, use of an OOB for upstream and downstream management traffic requires the STB to have separate receiver and transmitter because the OOB channels are frequency division multiplexed on the HFC from the channels carrying digital and analog services. Use of an upstream OOB shared by multiple STBs also requires each STB to have a MAC protocol if the STB will transmit spontaneously without waiting for a poll from the head end.

Some prior art cable systems have used in-band delivery of system messages as part of the 6 MHz channel, but the conventional wisdom is that in-band delivery has several significant problems. First, to guarantee delivery, the in-band management messages have to be simulcast on every 6 MHz channel since the STB tuner could be tuned to any channel and can only be tuned to one channel at a time. Simulcasting on every channel consumes a considerable amount of system bandwidth and requires message insertion equipment for every channel thereby making the head end more complex and expensive. Further, NTSC analog channels have very limited (about 9,600 bits per second) capacity to carry digital information in the vertical blanking interval. Further, in one way systems where there is no return path, system messages are broadcast as a circular queue which is repeatedly transmitted. In large systems, this causes considerable queuing delay because of the volume of system messages. Digital channels provide a considerable increase in data capacity, but system messages must be delivered regardless of whether the STB is tuned to an analog or a digital channel so it is impossible to take advantage of the increased payload of digital channels. This problem can only be solved by including in the STB separate tuners for the analog and digital channels, but this increases the cost of the STB.

Direct Broadcast Satellite (DBS) systems have no OOB channel, and every channel is digital and carries 6-12 subchannels of services. Management and control messages are simulcast in-band as a data carousel on each digital channel at a rate of several hundred kilobits per second thereby consuming an overhead of about 1%. This is because there is no real time upstream in a DBS system. Therefore, because a tuner may be tuned to any channel on the system and may need any particular application software or other piece of M&C data, all the M&C data must be transmitted on all channels continuously on a revolving data-carousel basis. There is a phone line connection to each DBS receiver, but it is only used for callback purposes to upload pay-per-view data and verify that the DBS receiver is still where the customer originally said it was and has not been moved to a neighbor's house. Because there is no real time upstream in a DBS system, the headend does not know to which channels various tuners in the system are tuned. That is why M&C data must be simulcast on every channel. However, DBS receivers are single tuner and M&C data is transmitted in-band so they probably represent the closest prior art. DBS receivers however still need a separate modem and software to send data upstream.

The need to simulcast M&C data on all channels in DBS systems is why cable system operators value the OOB highly. The OOB channel eliminates the need to simulcast management and control messages on every channel simultaneously and waste large amounts of bandwidth. However, an OOB channel requires a separate tuner in the STB which complicates it and renders it more expensive.

Early OOB channels were limited in-bandwidth, but with higher rate silicon chips now available, system messages only occupy 10% of OOB channel capacity. However, each STB still needs an OOB tuner and an upstream MAC protocol in addition to the tuners for the digital and analog forward channels so the STB is more expensive than it needs to be. The remaining 90% is ear marked for extended services like e-mail, extended program guides, network games, etc.

Upstream OOB channel options availble in the prior art are DVS-178, DVS-167 (developed by the Digital Audio Video Council or DAVIC) and DOCSIS cable modem. The DOCSIS cable modem standard was designed as an in-band mechanism for data transport, but if an additional tuner is added to the STB, with one of the tuners devoted to the DOCSIS channel, the DOCSIS data transport protocol can be made to perform all the functions of DVS-178, DVS-167 in the out-of-band channel. This still requires the use of at least two tuners (one of which is in the DOCSIS cable modem) in the STB and it requires all the circuitry and software of a DOCSIS cable modem to implement the DOCSIS protocol to send and receive management messages on the OOB.

OOB channels as they have evolved today, as with any data communications network, require protocols for address management, message routing, network management and the like. The OOB channel can use the TCP/IP protocol to avoid re-inventing the wheel. TCP/IP provides a connectionless service to each STB that allows messages to be sent to each STB individually without the overhead of establishing a connection which is very important because there may be thousands of STBs. TCP/IP capable routers and equipment are readily available and cheap, and provides the ability to aggregate return channel traffic to efficiently use the upstream bandwidth.

However, an OOB still requires a separate tuner in the STB and circuitry and software to implement these protocols thereby complicating the STB.

Sony is believed to have developed and deployed via Cable Vision an interactive video delivery system that uses DOCSIS for a bidirectional OOB channel with interactive and VOD services delivered on a different non DOCSIS MPEG-2 multiplex. This system still needs two tuners in each STB, one for the video and the other in the DOCSIS modem within the STB and still suffers from the disadvantages of having to use an out-of-band channel. The DOCSIS modem just replaces the QPSK OOB transceiver circuitry in the Pegasus STBs. Conditional access is believed to be carried out in a conventional manner.

The simulcast of data carousels of system management data, conditional access keys, application programs, program guide data, etc. even on an OOB channel is wasteful. Most of the consumed downstream OOB bandwidth is wasted because the STBs that are in operation at the time and tuned to the OOB channel do not need most of the information which is in the data carousel.

Sending of conditional access data in-band is not new as EMM messages have been sent in the prior art on the private data PID of an MPEG transport stream. A company called Canal+ from France and its competitors Nagravision and NDS provide encyrption services to the satellite direct broadcast systems and other systems. Canal+ is a provider of digital and interactive TV software solutions for set top boxes on cable, satellite and digital terrestial networks. The Canal+ open digital interactive TV system is marketed under the trademark Media Highway. This system allows consumers to turn their televisions into multimedia home entertainment centers by allowing consumers to connect digital devices such as DVD, DVHS and home computers to their set top boxes and allows fast internet access via satellite, cable, terrestial and modem networks as well as push technology that provides continuous broadcasting of data to subscribers such as stock exchange information. The Media Highway provides two types of interactivity: carousel and online. Carousel interactivity meant that data such as that comprising electronic program guide data is broadcast cyclically to customers which they can then interact with locally. Usually this is done when there is no return path. In this carousel type interactivity, conditional access keys are sent in-band ahead of time and stored in the set top boxes for use when needed. In other words, all working keys for all services to which a customer having that STB has subscribed and session keys for that set top box are sent to the set top box ahead of time and stored there. The encrypted data of the program is broadcast cyclically as a data carousel. When the user wants to view an encrypted program, the appropriate keys are read from storage and used to decrypt the video program or service data. The other form of interactivity is online. Online interactivity means there is some sort of return path which allows the STB to send messages upstream to a remote server requesting services for example or requesting download of the software application for an interactive network game for storage and execution on an STB. Software upgrades and patches for the STB can be downloaded and stored in STB flash memory and software applications can be downloaded into flash memory as resident applications or into RAM of the STB when needed.

The Media Highway system provides for security by providing a proprietary application program authentication system to authenticate software to be downloaded at the transmission level. The Media Highway system also provides a conditional access system which controls user access to individual programs through smart cards inserted into the STB (or other implementations of a secure processor). Downloaded application programs are authenticated so pirated applications that do not pass the authentication process cannot be executed. All this is implemented by building a Media Highway middleware virtual machine in each STB with a unique Device Layer Interface (DLI) which the manufacturer of the STB must build its STB to be compatible with. If the STB is built to port to the DLI, its card reader, modem, LED display, clock and loader software will work with the Media Highway virtual machine and allow the above noted features to be used. If the manufacturer uses application development tools supplied by Canal+to develop software, it will be compatible with the virtual machine.

The Canal+ conditional access system is marketed under the trademark MediaGuard. Under this system, a subscription authorization system at the headend delivers access rights in the form of session keys in Entitlement Management Messages (EMMs) to the smart cards inserted in the STB of a customer who has ordered an encrypted service. There are two ciphering units. The first encrypts the EMM to be sent to an STB, presumably with the private user key of the STB which ordered the service. The other cipher unit is located at the digital broadcast center and encrypts the service keys in Entitlement Control Messages. The service keys are keys which are used to encrypt the payloads of the packets containing the data of the service. The ECMs are inserted in the broadcast MPEG transport streams of the MPEG multiplex. These ECMs are recovered and the encrypted service keys therein are decrypted using the session keys in the EMM message. The EMM are sent in the MPEG multiplex also, probably in MPEG packets having the private data PID. At the STB, the encrypted ECM and EMM messages are sent to the secure processor in the smart card and the private user key is used to decrypt the EMM message and recover the session key. The session key is then used to decrypt the ECM message and recover the control word or service key which is sent to the decryption engine to decrypt the payloads of the MPEG packets bearing the service data.

The ECMs and EMMs are believed to be sent to STBs in the MediaGuard prior art on a targeted basis if there is an upstream return path, and the ECMs are believed to be sent as a data carousel if there is no return path with targeted EMM messages sent in-band ahead of time to all STBs that have subscriptions to certain services for storage. This allows the STB to call the session key out of memory when the user orders a service to which he has subscribed and use the session key to recover the service key or control word. The ECMs are still believed to be sent as a data carousel even when there is a return path.

In this Canal+ prior art system, impulse pay per view requires the use of tokens in the smart card wallet and a callback procedure via some data path, usually a telephone line, to collect payment information from the smart card. This requires special communication servers to imlement the callback procedure and process the collected data. The callback does not happen in real time so the success of an event is not immediately known until the callbacks are made. In contrast, using the DOCSIS in-band M&C downstream channel and a coupled DOCSIS upstream channel to send and receive M&C and conditional access data does not require a special communication server to do the callback from the head end and allows immediate determination the success of an event based upon the number of subscribers.

The Canal+ advanced pay-per-view mode of operation is the same as the impulse pay-per-view operation but also includes a real-time, on-line PPV mode wherein one of the communication servers used for the callback receives direct upstream real time commands from the STB, a touch tone telephone, an interactive videotext service such as the Minitel or requires an OOB channel to send upstream data with the necessary circuitry and MAC protocol in the STB for the OOB channel.

Therefore, a need has arisen for methods and apparatus to solve all these problems including primarily reducing the cost of the set top decoder boxes needed to receive digital broadcasts, interactive and on demand services, allowing the use of application software download, simplifying and rendering more efficient the data carousel and conditional access functions in a way that they can be carried out with targeted transmissions in real time to specific STBs so as to not waste bandwidth.

### SUMMARY OF THE INVENTION

According to one significant teaching of the invention, the expense and complexity of the set top boxes in an interactive digital cable system can be reduced by eliminating the out-of-band channels of the prior art systems and allowing single tuner STBs. This is done by transmitting the management and control data (hereafter the M&C data) in-band in the same RF channel the encrypted service data is transmitted upon. This is done by encapsulating the M&C data in MPEG packets having the DOCSIS PID and putting these packets in an MPEG-2 transport stream used to deliver the compressed audio, video and data of the delivered services (digital broadcasts, interactive and on demand services hereafter referred to as the services). A pure DOCSIS upstream in the RF on the HFC is used for upstream M&C data. This eliminates the OOB tuner in prior art STBs and eliminates the upstream phone line modem and associated software in the DBS receivers. A single DOCSIS cable modem modified according to the teachings herein can tune the services and recover the MPEG packets thereof, and can tune and recover the MPEG packets containing the M&C downstream data including conditional access data, and send M&C upstream data in real time on a pure DOCSIS upstream channel in the RF spectrum of the HFC.

The state of the prior art is that there are three data paths for communication of data two of which are for downstream transmissions and the third of which is for upstream transmissions. The first downstream data path is a radio frequency RF channel which carries the MPEG packets of the various services offered. The second downstream data patsh is for downstream transmission of M&C data and it can be an OOB channel in the RF on a separate frequency from the first channel in HFC systems or it can in-band on the private data PID in the case of the targeted EMM transmissions of the Canal+ system as applied to DBS satellite systems or in-band as a multicast of all M&C data as a data carousel simultaneously on all channels of the system in the DBS satellite systems like DirecTV or Dish Network. The third data path is the upstream return path which can be an intermittently used phone line of DBS systems (which cannot be real time because the phone line cannot be tied up indefinitely) or a separate upstream channel which is on all the time in the case of the Canal+ plus interactive online mode which can be either an RF channel if the STB has an upstream RF transmitter and upstream channel circuitry or an always on upstream DSL channel on the phone lines.

None of these prior art systems supports a single tuner in the form of a modified DOCSIS cable modem in the STB with an always on upstream channel using a pure DOCSIS channel transmitted by the DOCSIS cable modem and a downstream M&C channel using the DOCSIS PID which is also recovered by the DOCSIS cable modem. The single tuner aspect requires that the downstream M&C channel be on the same RF carrier as the service data and transmitted as MPEG packets having the DOCSIS PID, and it requires the upstream to be transmitted by the DOCSIS cable modem's transmitter and upstream channel circuitry. All the HFC system use separate OOB channels which requires the STB to have a second tuner and probably to have a MAC protocol to handle access to the OOB channel. In the prior art systems, where the M&C data is transmitted in-band such as the DBS systems, there is required separate upstream circuitry to interface with the DSL line or transmit the upstream M&C data on a separate RF channel (if always on real time upstream M&C data transmission is present) or a separate modem to transmit upstream on a Plain Old Telephone Service (POTS) line (in which case, no real time, always on upstream M&C data transmission would be present).

Since the downstream data is sent on a DOCSIS channel, in some embodiments, data of other DOCSIS services such a broadband internet access, voices-over-IP, DSL over cable, digital video recorder data recorded at the headend, video conference data, or any other DOCSIS data (referred to in the claims as DOCSIS service data) may also be sent over the DOCSIS channel. Targeted conditional access EMM messages may also be sent downstream to only the STBs that need them and only when they need them to decrypt a service the STB ordered via an upstream communication on a pure DOCSIS upstream. Use of DOCSIS upstream and downstream M&C channels eliminates the need for an EMM message data store ahead protocol such as is used in the DBS systems (which wastes downstream bandwidth and memory space in the STB). It also eliminates the need for a separate communication server at the head end to do callback protocol or to do the real time online interactive mode for advanced pay-per-view as taught in the Canal+ MediaGuard prior art. This is because the DOCSIS CMTS at the headend can handle both the downstream M&C transmissions and reception of upstream real time M&C data on the DOCSIS upstream. No separate server is needed for the upstream and no special or proprietary upstream media access protocol is required for the upstream channel since the DOCSIS protocol takes care of multiple access by the STBs to the upstream DOCSIS channel. In other words, the separate communication server required by the Canal+ headend can be eliminated because the DOCSIS CMTS normal messaging functions can be used to send the M&C and targeted conditional access data downstream in response to upstream M&C messages received at the CMTS. These upstream M&C requests request downloads of particular services, the conditional access data to decrypt them, program guide data, application data and other M&C data. The normal DOCSIS mechanisms for provisioning cable modems and authenticating software downloads to STBs may also be used thereby eliminating the need to develop or use proprietary mechanisms to do these necessary functions.

References to MPEG-2 or MPEG in this application or the appended claims are to be understood as referring to any data compression scheme suitable for sending video, audio and other data of interactive services, digital video broadcast, or video-on-demand services. Interactive services can be anything requiring upstream communication from the set top boxes to the head end including broadband internet access via a computer coupled to the set top box. Although the invention is currently to send the M&C data in-band over the DOCSIS PID on an MPEG transport stream so as to minimize overhead in interactive service delivery, if DOCSIS evolves into something other than IP over MPEG in the future years, whatever it evolves into will suffice to practice the invention as long as the M&C data can be sent in-band and segregated somehow from the on-demand and interactive services data.

There have been several proposals to send video of interactive and video-on-demand (VOD) services over IP and over the DOCSIS transport protocol. The invention is not to do either of those approaches. It is to send video and other interactive services over MPEG transport streams like was done in the Pegasus prior art but to put the M&C data in-band in the MPEG transport stream on the DOCSIS PID. M&C data can include the EMM conditional access key data in some embodiments where encrypted service data is being delivered. A normal DOCSIS upstream is used which can have one or more subchannels and can be DOCSIS 1.0, 1.1 or 2.0. Only M&C data is sent on the DOCSIS upstream in the preferred embodiment. However, in alternative embodiments, other DOCSIS service data can share the DOCSIS upstream such as broadband internet access, voice-over-IP, security camera video-over-IP data, etc.

This use of a DOCSIS inband M&C channel allows great simplification of the STBs by elimination of the transceiver circuitry in each STB that was devoted in the prior art to just sending and receiving OOB data on the out-of-band channel. It also eliminates the media access control protocol that was required in the prior art if the upstream OOB channel was shared. An STB which is compatible with the present invention only needs one tuner and circuitry from a DOCSIS modem which can demultiplex the MPEG packets in each transport stream and route them to the correct circuitry in the STB for use in management and control or to extract the video, audio and/or data of the services. In other words, the DOCSIS modem in the STB tunes the MPEG-2 multiplex, filters out and processes DOCSIS PID bearing MPEG-2 packets and filters out MPEG-2 packets having PIDS of the desired services and sends them to the proper STB circuitry for key extraction, decryption of service data, NTSC signal generation, loading of software, display of program guide data, etc. The DOCSIS modem circuitry in the STB is also used to transmit the conventional DOCSIS upstream to support the in-band DOCSIS M&C channel(s).

The prior art FSN assigned timeslots on the OOB channel wasted upstream OOB bandwidth. This lesson resulted in the DAVIC OOB reservation protocol. However, the DOCSIS protocol supports much higher data rates in both the forward and reverse channels, and with the advent of DOCSIS 2.0, even higher data rates are supported. Further, no separate MAC protocol to manage a shared upstream OOB is necessary with the invention because the DOCSIS protocol carried out on the DOCIS PID takes care of the MAC functions.

Normal DOCSIS media access control protocols are carried out with upstream and downstream DOCSIS messages. These include ranging requests, ranging response messages, MAP and UCD messages, etc. All are transmitted downstream on the DOCSIS PID of the MPEG-2 multiplex. Upstream DOCSIS messages such as ranging bursts which are transmitted during the ranging contention window identified in the MAP, bandwidth requests, and messages containing M&C data are transmitted by the modified DOCSIS cable modem in the STB during contention windows or assigned upstream minislots as controlled by the CMTS through MAP messages. The ranging contention window is a contiguous group of upstream minislots identified in a downstream MAP message. Upstream data bursts carrying upstream M&C data and other DOCSIS data are transmitted during the minislots assigned in MAP messages sent in response to upstream M&C bandwidth request messages transmitted on the upstream DOCSIS channel during bandwidth request contention windows assigned in MAP messages. Because the bandwidth on the upstream DOCSIS channel is scheduled and fully utilized, there is no waste of upstream OOB bandwidth as there was in the FSN prior art where specific upstream timeslots were reserved for particular STBs even if they had no upstream traffic.

The higher downstream and upstream data capacity of a DOCSIS M&C channel allows the operating system software and navigation software to be downloaded from the head end over the DOCSIS PID instead of being forced to keep it resident on the STB as was the case in the Pegasus prior art in some embodiments although the preferred embodiment keeps the navigation and operating system software resident on the STB for faster operation. The Pegasus prior art system was forced to keep the navigation and OS software resident to eliminate upstream bottlenecks caused by 4000 STBs constantly requesting software downloads. The Pegasus approach reduced the network resources that were consumed in downloading these applications constantly to the 4000 Pegasus STBs each time a button on the remote control was pushed. OOB software application downloads were discouraged on Pegasus, and MPEG-2 private data carousels were used for these purposes.

Transmission of the M&C data on the DOCSIS PID in an MPEG-2 transport stream also minimizes the overhead associated with managing interactive services and VOD. Since DOCSIS is essentially IP over MPEG, this brings the benefit of the well understood IP protocols and addressibility to managing interactive services and all auxiliary devices such as personal computers connected to the STB. The IP layer functionality is used to add addressing capability to the downstream traffic so that application software downloads, program guide data, conditional access data, etc. can be requested in upstream messages from specific STBs and transmitted downstream to only the STB that requested it without using data carousels that waste bandwidth.

There are significant advantages to using the DOCSIS data transport protocol to implement a DOCSIS in-band management and control channel with a DOCSIS PID on an MPEG-2 transport stream. The MPEG-2 transport stream or mulitplex can be used to transmit all the in-band service delivery channels and replace all OOB management channels. This allows elimination of all STB circuitry formerly needed in the prior art systems such as Pegasus, FSN, Digicable and Canal+ to communicate on the OOB channel or a DSL link or POTS phone line. Further, all the overhead reduction efficiencies of use of MPEG-2 transport without overlaying it on the ATM transport mechanism are enjoyed by this invention. Using a DOCSIS channel with all its protocol messages to deliver M&C data on a DOCSIS PID inside the MPEG-2 transport stream greatly reduces the overhead of the transport mechanism used to deliver the services data. This is because the transport mechanism is a modified MPEG-2 transport stream and not an MPEG-2 transport stream segmented into ATM cells as in the FSN prior art. Recall that the MPEG over ATM transport protocol of the Time Warner FSN suffered from 12% overhead just to use the ATM transport protocol, mainly because of the 5 byte header in every ATM cell. Thus, the heavy overhead burden of trying to send MPEG frames over ATM infrastructure like the Time Warner Full Service Network is avoided in the invention described here.

The simplification of the set top decoder (STB) is highly significant because the costs of deploying millions of complex STBs nationwide are prohibitive to cable operators, and will slow penetration of the interactive and VOD services over HFC into the nationwide market.

The DOCSIS cable modem used in the STB has been modified to receive filter commands from the STB microprocessor, select the MPEG packets in the MPEG transport stream having the DOCSIS PID and recover the downstream M&C data that was formerly sent on the forward OOB channel in the prior art and send it to the proper circuitry in the STB. For example, EMM conditional access messages on the DOCSIS PID are extracted, recognized as EMM messages and sent to the STB microprocessor where only EMM messages addressed to the particular STB are kept and the encrypted session key therein is decrypted using the private user key of the STB. The DOCSIS cable modem is also modified to extract from the received MPEG-2 multiplex the MPEG packets having PIDs of the selected service(s) and supply those packets to a conditional access decryption and decompression circuitry. The decompressed data is then supplied to a processor for graphics rendering and NTSC, PAL or SECAM or other format signal generation. The DOCSIS modem is also modified to receive the upstream M&C data and transmit it on a conventional DOCSIS upstream channel.

In contrast to the Canal+ and DBS prior art, the preferred embodiment of the invention uses a targeted, non carousel approach to send only M&C data (including targeted conditional access EMM key data) that is requested via a real time, always on upstream DOCSIS channel to only the STBs that requested it. No separate proprietary communication protocol is needed for callbacks, provisioning, secure software downloads or other STB management from the head end since the DOCSIS always on upstream and downstream channels either eliminates the need for these functions or the DOCSIS protocol already has known mechanisms in place to carry these functions out. ECM messages are sent in the transport stream with PIDs of the associated service.

In short, comparing the invention to the DBS, Canal+, FSN and Pegasus prior art, the invention is: reception of upstream messages on an always-on, conventional DOCSIS channel from the set top boxes; these upstream messages, among other things, define what M&C data the STB needs; and, transmission of only the needed M&C data to only the STBs that need it in-band via a DOCSIS channel on a DOCSIS PID within a downstream MPEG-2 multiplex which also delivers the digital services data. This is done by using IP packets or any other type of packet or cell that can be addressed to a particular STB or which can be multicast (hereafter just referred to as IP packets). These IP packets are encapsulated in MAC frames which are encapsulated in MPEG-2 packets which have the reserved DOCSIS PID. These MPEG packet are multiplexed into an MPEG transport stream mulitplex which carries the compressed video, audio and data of the delivered services. For shorthand, this summary of the idea of the invention will be referred to a thin DOCSIS or a bidirectional DOCSIS M&C channel elsewhere herein.

Application software download via the thin DOCSIS channel, in addition to simplifying the STB, also allows bugs to be fixed from the head end, upgrades to be loaded from the head end and new features to be added from the head end thereby rendering the STB future proof. The problems in the prior art with overwhelming the OOB forward channel with application download and overwhelming the OOB upstream channel bandwidth with too many simultaneous requests for application downloads is overcome by the fact that DOCSIS 2.0 upstream M&C channels allow synchronous code division multiplexed bursts. This greatly increases the DOCSIS upstream channel traffic capacity, and allows many STBs to simultaneously use the DOCSIS upstream using the DOCSIS upstream bandwidth assignment protocol. This protocol is contention based for upstream bandwidth requests but once a request is granted, no collisions will occur because the headend controls who can transmit and when.

Another advantage of using a DOCSIS M&C channel is in implementation of conditional access. Current conditional access requires each STB to have a smart card or other embedded security circuitry in each STB which adds cost to the STB. In conventional conditional access systems, a secure microprocessor (sometimes on a smart card) sends purchase information on the OOB channel and Entitlement Management Messages (EMM) messages containing encrypted session keys authorizing access are sent back on the OOB channel to the secure microprocessor in the case of HFC or on the private data PID in the case of Canal+ technology on a DBS system. This approach required the STB to have a separate receiver for the OOB channel or special software to extract the private data PID EMM messages, route them and decrypt them using the private user key of the STB. An encrypted MPEG-2 multiplex carrying the delivered services is routed in the STB to an MPEG-2 transport demultiplexer which separates the stream into separate streams based upon the PIDs and selects the video, audio and data packetized elementary streams (PES) for the selected service or program. Entitlement control messages (ECM) in the MPEG-2 transport streams of the prior art conditional access system were encrypted messages that carried the encryption keys. The transport demultiplexer selected the ECMs that apply to the desired, protected program and sent them to the secure microprocessor. The ECMs were decrypted by the secure microprocessor using the decrypted EMM session keys, and the resulting payload decryption keys called working keys were sent to the payload decryption engine. The payload decryption engine uses these working keys to decrypt the payload sections of the PES in the MPEG packets having the PIDs of the selected encrypted program.

A summary of the significant advantages of using a DOCSIS M&C channel are: (1) secure application software download from the head end to each STB as the application program is needed via the DOCSIS PID thereby simplifying the STB and reducing its memory requirements and rendering it bug proof, easily upgradeable, flexible and future proof; (2) use of the alway-on, conventional DOCSIS upstream channel by each STB to send upstream messages indicating the exact application program(s) and other M&C data it needs so only the necessary application software and M&C data is downloaded via the DOCSIS PID to only the STB that requested it thereby preventing the waste of bandwidth intrinsic to a data carousel; (3) simplification of the STB by elimination of a tuner and MAC protocol for an OOB channel and elimination of any circuitry needed to interface to a DSL or POTS phone line; (4) reduction in overhead in delivery of digital services; (5) elimination of wasted bandwidth on the upstream M&C channel; (6) upgrades, bug fixes and adding new features to STBs from head end without need to obsolete existing equipment; (7) simplification of the conditional access process and elimination of a callback server at the head end dedicated to conditional access; and (7) use of existing cable modem termination systems to manage STBs from the headend.

### BRIEF DESCRIPTION OF THE DRAWINGS

FIG. 1 is a diagram of the prior art protocol stack of the Time Warner Full Service Network showing MPEG compressed audio and video transmitted over an ATM infrastructure.

FIG. 2 is a diagram of the prior art Pegasus 2 channel types showing use of an OOB.

FIG. 3 is a diagram of the prior art Pegasus 2 QAM switching matrix which was used to overcome the fact that MPEG-2 was not designed to work in packet switched networks.

FIG. 4 is another diagram of the prior art Time Warner Full Service Network communication protocol stack showing TDMA and QPSK OOB control channel and QAM modulated channels carrying ATM cells carrying MPEG packets for delivery of data of interactive and on demand services.

FIG. 5 is a block diagram of just the digital services headend downstream-only apparatus to transmit digital video broadcast programs on HFC systems along with Video-on-demand and Interactive services using a DOCSIS in-band channel to transmit management and control data (M&C data) that was transmitted out-of-band in the prior art interactive and VOD service delivery systems over HFC.

FIG. 6 is a more detailed diagram of the DOCSIS communication protocol stack on the RF interface to the HFC that comprise blocks 20, 21 and 30 in FIG. 5, showing how additional functionality to manage STBs from a CMTS at the head end can be implemented.

FIG. 7 is a more detailed block diagram showing the protocol stacks for the upstream and downstream at both the CMTS and CM ends showing how the OOB or management and control data and the interactive services and video on demad data are merged into a combined MPEG-2 transport stream and sent to the physical media dependent layer and transmitted over the HFC. FIG. 8 is a block diagram of a simple set top box with a single tuner for receiving interactive and VOD data and other services along with a DOCSIS in-band management and control channel to manage the STB and the delivered services.

FIG. 9 represents an alternative embodiment of a single tuner STB where the NTSC/PAL/SECAM encoder 156 is a multimedia graphics processor which genererates an analog television signal of the proper format and overlays graphics on the displayed images to display program guide data, navigation information, and whatever other graphics information is needed.

FIG. 10 represents an alternative embodiment of a single tuner STB with TIVO type digital video recording capability.

FIG. 11 is a block diagram of another embodiment for a single tuner STB which can receive JVT compressed data or MPEG compressed data.

FIG. 12 is a diagram showing how EMM and ECM messages are extracted from the MPEG multiplex.

FIG. 13 is a flow diagram of the process of receiving upstream requests for management and control data and responding by sending the requested management and control data downstream on the DOCSIS PID.

FIGS. 14A through 14C are a flowchart of the process carried out at the headend to send targeted EMM messages to only the STBs that have ordered services via the DOCSIS PID.

FIGS. 15A through 15C are a flowchart of the process carried out in the STB to recover ECM and EMM messages and decrypt payload data of a requested service.

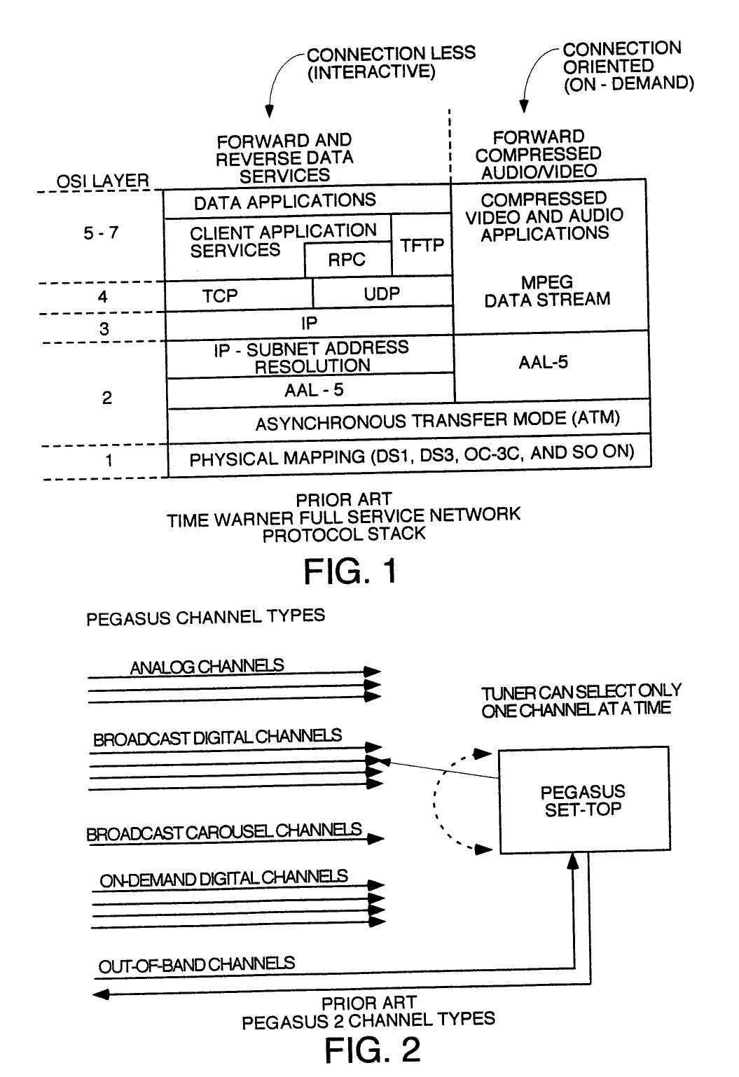

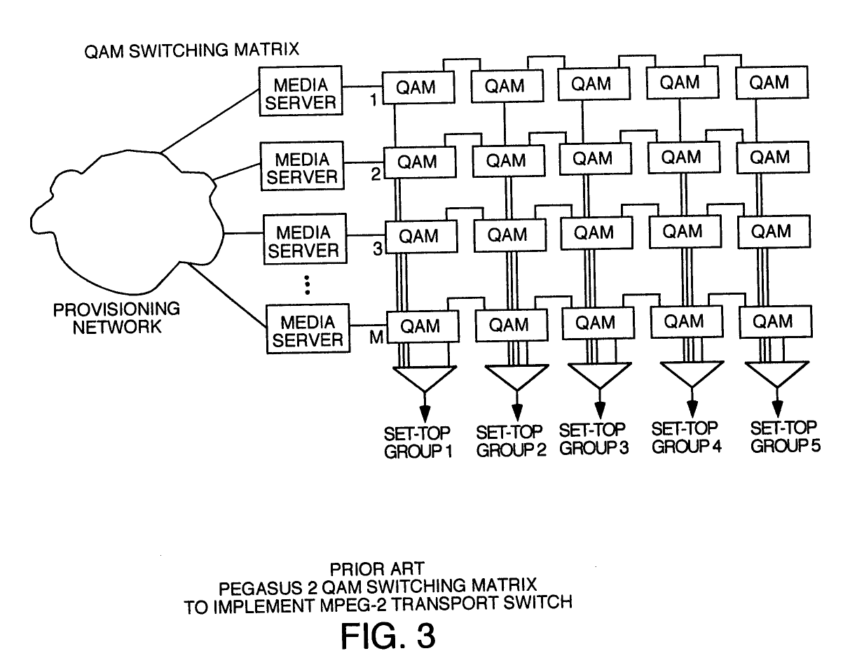

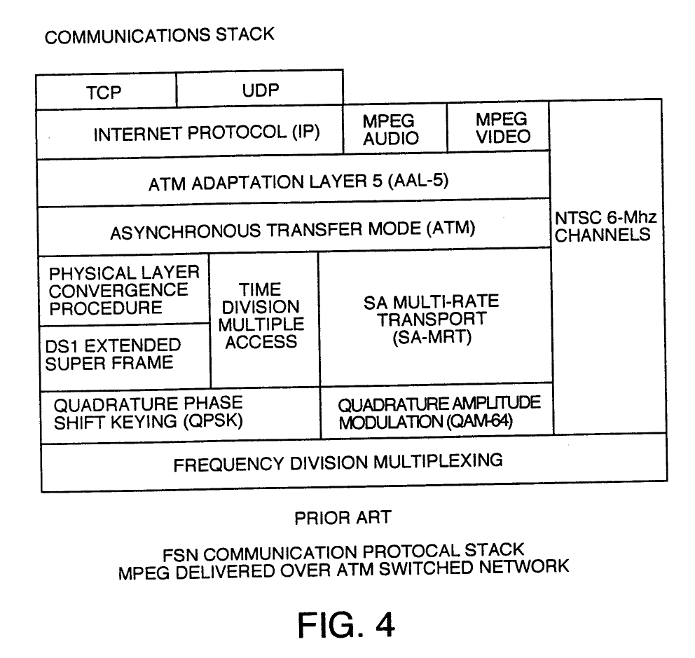

### DETAILED DESCRIPTION OF THE PREFERRED AND ALTERNATIVE EMBODIMENTS

To understand the invention, some background on the DOCSIS data over cable technology is useful. DOCSIS is a series of specifications developed by Cable Labs, which is a consortium of cable system operators defining standards for transmitting data over HFC systems from a headend to a plurality of cable modems. DOCSIS is a set of standards that define the requirements of, inter alia, a physical media dependent layer, a transmission convergence layer and a media access control layer (protocols for messaging to accomplish access control to the media and management of the cable modems) in order to send data, video and audio digitally in compressed form bidirectionally over hybrid fiber coaxial cable CATV systems between a headend and a plurality of cable modems or set top boxes that can receive DOCSIS channels.

There are three versions of the DOCSIS specification, all of which are incorporated by reference herein and all of which are cited hereby as prior art: DOCSIS 1.0, 1.1 and 2.0. The differences are in the allowed burst modulation types, symbol rates, etc. For example, in DOCSIS 2.0, synchronous code division multiplexed bursts are allowed while in DOCSIS 1.0 and 1.1, they are not.

DOCSIS is essentially delivery of Internet Protocol datagrams encapsulated in MPEG packets, so it fits perfectly within an MPEG-2 transport stream. In other words, the MPEG packets that carry DOCSIS data can be inserted into an MPEG-2 transport stream carrying the compressed video and audio and supplemental data of interactive and on demand services or digital broadcasts, each of which has its own Program Identifier(s) or PID(s). This can be done without affecting the MPEG-2 transport stream. This is because the DOCSIS MPEG packets all have a Program Identifier or PID which identifies them as DOCSIS packets. This allows the cable modem or STB at the receiving end to separate out the DOCSIS MPEG packets from the MPEG packets in the same transport stream having the PIDs of the interactive or on demand services or the digital broadcast programs. The various streams of MPEG packets for each type of service can be routed to the appropriate circuitry in the cable modem or STB for further processing.

DOCSIS was originally designed to allow transmission of IP data packets transparently from the head end (having a server coupled to the internet or any other source of IP packets) to hundreds or thousands of cable modems over an HFC system. This would allow users to connect to the internet through their CATV systems instead of through slow dial up connections to their ISPs using phone lines. The Internet Protocol (IP) is a protocol used in the packet switched internet and other networks for connectionless delivery of datagrams. Connectionless means that no dedicated line or circuit is used to deliver an entire message or datagram, and messages are broken into packets where each is treated independently.

However, the IP packets transmitted over the DOCSIS channel can come from anywhere and can be used to encapsulate requested application software applications downloads, requested program guide data, data carousels, network management and control data, SNMP management data to allow the headend to manage the STBs, messages to implement the DOCSIS ranging and network management included in the DOCSIS media access control protocol, etc.

DOCSIS Cable Modem Termination Systems (CMTS) receive IP packets via the TCP/IP protocol and encapsulate them into MPEG packets having a header PID set to 0×1FFE to identify the MPEG packet as DOCSIS data. The MPEG packets are then broken down into ATM protocol data units (APDUs) in some embodiments, as defined in the IEEE 802.14 specification. However, in other embodiments, the MPEG packets are not broken down into APDUs and are broken directly into Reed Solomon coding blocks. These APDUs are broken into Reed Solomon (RS) coding blocks for forward error correction encoding with error detection and correction bits for each block. The RS blocks are then interleaved and broken down into symbols which are interleaved and may or may not be Trellis encoded into constellation points for transmission on the HFC.

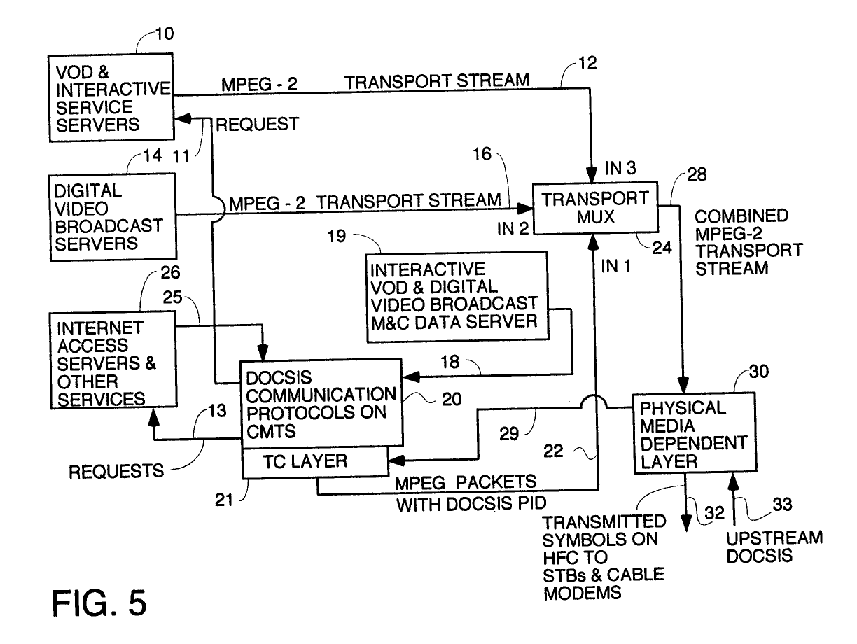

FIG. 5 is a block diagram of just the digital services headend downstream-only apparatus to transmit digital video broadcast programs on HFC systems along with Video-on-demand and Interactive services using a DOCSIS in-band channel to transmit management and control data (M&C data) that was transmitted out-of-band in the prior art interactive and VOD service delivery systems over HFC. The analog NTSC transmission circuitry and the upstream DOCSIS channel and MPEG-2 transport stream reception circuitry is not shown in FIG. 5 so as to highlight the basic idea of the invention without undue complexity although at least an upstream DOCSIS channel carrying upstream management and control data is required to implement interactive and VOD services. One or more servers 10 receive requests for interactive services via line 11 from a Cable Modem Termination System 20 (CMTS). The CMTS 20 is, in the preferred embodiment, a server executing industry standard DOCSIS communication protocol processes to process upstream DOCSIS communications on a pure DOCSIS upstream channel 33 on the HFC. Set top boxes receive commands from users for interactive services and video-on-demand transmissions and requests for other services delivered via IP packets over the internet. In some STBs, especially those with LAN connections to personal computer running web browsers and e-mail clients, users can request e-mail, surf the web via their PC or a wireless keyboard coupled to the STB by an infrared or radio frequency connection and request downloads and web pages. Those requests as well as other conventional DOCSIS messages, such as ranging bursts, upstream bandwidth requests, etc., are converted to management and control packets (M&C upstream data) and encapsulated by a DOCSIS compatible cable modem (CM) transmitter in the STB into IP packets addressed to the appropriate server at the head end or on the internet. The IP packets are encapsulated by the STB CM transmitter into MAC frames addressed to MAC addresses in the servers and the MAC frames are encapsulated into MPEG packets which are broken down into forward error corrected (FEC) symbols which are transmitted by the STB DOCSIS cable modem transmitter on upstream DOCSIS channel 33.

At the head end, a physical media dependent layer 30 recovers the upstream MPEG packets from the DOCSIS upstream and sends them via data path 29 to a transmission convergence sublayer process 21. There, the MAC frames are recovered from the MPEG packets and routed to the other DOCSIS layers which recover the IP packets and do other conventional DOCSIS processing for ranging, upstream bandwidth requests, etc. The IP packets are then routed to the appropriate servers such that IP packets bearing requests for interactive services get routed to server 10 and IP packets bearing requests for internet access or other services delivered by IP packets get routed to server 26 via data path 13.

Server(s) 10 respond to said requests by outputting requested VOD and/or interactive services requested by the customer on line 12 as an MPEG transport stream. One or more servers 14 output regularly scheduled or near video-on-demand digital video broadcast programs on line 16 as another MPEG-2 transport stream. Line 18 carries management and control data retrieved or generated by a managment and control data server 19 which may or may not be the same as servers 10, 14 or 26. The M&C data on line 18 is data that was formerly sent on a downstream OOB channel in the prior art. The M&C data is supplied to a set of DOCSIS communication protocol processes 20 which encapsulates it into IP packets which are then encapsulated in MAC frames addressed to particular STBs or multicast. The MAC frames are encapsulated into MPEG packts having the DOCSIS PID in transmission convergence layer 21, and sent to a transport multiplexer 24 via data path 22. Other data such as is supplied by server 26 providing other services such as internet access may also be supplied to DOCSIS communication protocols 20. There, the data of said other services, if not already encapsulated in IP packets, is encapsulated in IP packets addressed to the IP address of the process which requested the data. These IP packets are encapsulated in MAC frames addressed to the STB having or connected to the device and process which requested the other service data. These MAC frames are then encapsulated in MPEG packets having the DOCSIS PID in the preferred embodiment, but in alternative embodiments, the CMTS 20 may be programmed only to put management and control data on the DOCSIS PID and to put high speed of other services in MPEG packets having the private data PID. For example, not shown but possible is a video server which outputs video-over-IP IP packets. These also would be supplied to DOCSIS communication protocols 20 and encapsulated into MAC frames which are encapsulated in MPEG packets having the DOCSIS PID or the private data PID.

MPEG packets, as the term is used herein means fixed length 188 byte packets that comprise an MPEG-2 transport stream. Each has a 4-byte header which includes a PID field and a payload section. DOCSIS MAC frames can be put into the payload section, and when that is true, the PID field has a predetermined value indicating the payload section contains DOCSIS data. The MPEG packets on line 22 have a DOCSIS PID.

The management and control data on line 18 can include requested application software for download to the STBs, requested program guide data, conditional access key data such as EMM messages, event provisioning data, emergency alert service data, and messages to manage and control the interactive and VOD services, and targeted advertising, etc. Upstream management and control data on DOCSIS channel 33 can include: requests for interactive and/or VOD service, conventional DOCSIS messages, management and control messages pertaining to the interactive services, requests for specific application software downloads, requests for specified program guide data, purchase requests for pay-per-view events, gaming upstream data, requests for specific conditional access key data, agent data from agent programs in STBs that monitor viewer habits for use by advertisers in transmitting targeted advertising data to specific STBs, etc.

The transport multiplexer 24 combines the MPEG packets on line 22 with the MPEG transport streams on lines 12 and 16 to create an MPEG multiplex. The transport multiplexer 24 also adjusts the data in the tables of each transport stream and the multiplex itself to generate a combined MPEG-2 multiplex comprised of several MPEG-2 transport streams on line 28. The combined MPEG-2 multiplex has MPEG packets from lines 12, 16 and 22 interleaved thereon along with a Program Association Table (PAT). The PAT table is transmitted in MPEG packets having PID 0 and serves to define which MPEG-2 transport streams are in the multiplex. Each MPEG-2 transport stream has MPEG packets in it with a program map PID. These packets with the program MAP PID can be selected at the receiving end and a program map table or PMT can be extracted from the payload portions of these packets. The PMT table contains data that identifies the PIDs of the packets which contain the data of each program, service or other flow along with timing and conditional access data MPEG packets that are part of the program or service and which are contained in the MPEG-2 transport stream from which the PMT was extracted. The transport multiplexer 24 writes data into the Program Association Table to identify the transport streams on lines 12 and 16. However, the data on line 22 is in MPEG packets having the DOCSIS PID so no entry in the PAT table is necessary. This is because the DOCSIS PID is a reserved PID and has no entry in either the PMT or PAT. The data written into the Program Association Table of each MPEG-2 multiplex identifies which interactive services, digital video broadcasts, video-on-demand, or internet access services are in each transport stream of the MPEG multiplex.

At the receiving end, when a particular program or flow is desired, the MPEG packets having any of the PIDs listed in the PMT for the program or flow can be extracted from the stream and their payload data sent to conditional access circuitry for decryption and to MPEG video decoders for decompression. In the STB, M&C data or internet access data on the DOCSIS PID and who MAC frames are addressed to the STB is extracted and routed to the appropriate circuitry in the STB or in computers or other customer premises equipment coupled to the STB which needs the data.

The transport multiplexer 24 creates a single transport stream containing a collection of programs out of several transport streams in a manner which is conventional in the systems layer processing for the MPEG-2 systems layer processing. An MPEG-2 systems layer provides provides the functionality to extract a single program out of a single transport stream containing a collection of programs, or extract a subset of programs out of a single transport stream containing a collection of programs, or create a single transport stream containing a collection of programs out of several transport streams. The former functions are performed by the transport stream demultiplexers in each STB. The conventional functions of any MPEG-2 systems layer is to combine MPEG encoded video, audio, private data, time sync information and service and control information into a single MPEG-2 transport stream. The time sync information is timestamps that are used to synchronize the video, audio and data portions of a program. The private data can be any user defined data including M&C data normally sent on an OOB channel or any other data.

The MPEG-2 transport stream packets on line 28 are supplied to a physical media dependent layer (PMD) 30. The PMD layer encodes the MPEG packets into forward error correction protected symbols for transmission in accordance with the specifications of ITU-TJ.83-B, which is hereby incorporated by reference. Generally, the MPEG packets are broken into Reed Solomon blocks and encoded with error detection and correction bits. These blocks are then interleaved, and the interleaved stream is broken into segments usually comprised of 3 bits each and Trellis encoded to add a fourth redundant bit. These four bits then are divided into two bits that define the real component and two bits that define the imaginary components of a symbol for quadrature amplitude modulation and transmission on the HFC 32.

Every MPEG packet has a 4 byte header and a payload section which can contain any type of data. The header of every MPEG packet contains a program identifier or PID that defines to which service the data in the payload section belongs. For example, the packets containing compressed video data for a movie will have a particular PID, and the packets containing the audio data of the soundtrack of the movie will have a different PID. The combined packets along with some other MPEG-2 transport stream data structures will comprise one MPEG-2 transport stream for the program. Every MPEG-2 transport stream has MPEG packets therein having a program map PID in the headers thereof. The data in these packets define the aforementioned program map table (PMT) which defines which PIDs are part of each program in the MPEG-2 transport stream (hereafter just transport stream). The data in this PMT table is used at the STB to filter out just the packets from the proper transport stream that contain the video and audio (and possibly supplementary data such as displayed graphics, etc.) of the desired program.

To implement conditional access, packets with the PIDs of the desired program can be demultiplexed in the STB and private conditional access data on the DOCSIS PID is demultiplexed from the transport stream and supplied to conditional access circuitry to verify the user has authorization to view the program and to provide the necessary key to descramble it. If access is authorized, the MPEG packets of the selected program are descrambled by the conditional access circuitry in the STB. The descrambled MPEG packets are then supplied to MPEG decoder circuitry for decompression and creation of analog NTSC television signals from the data therein.

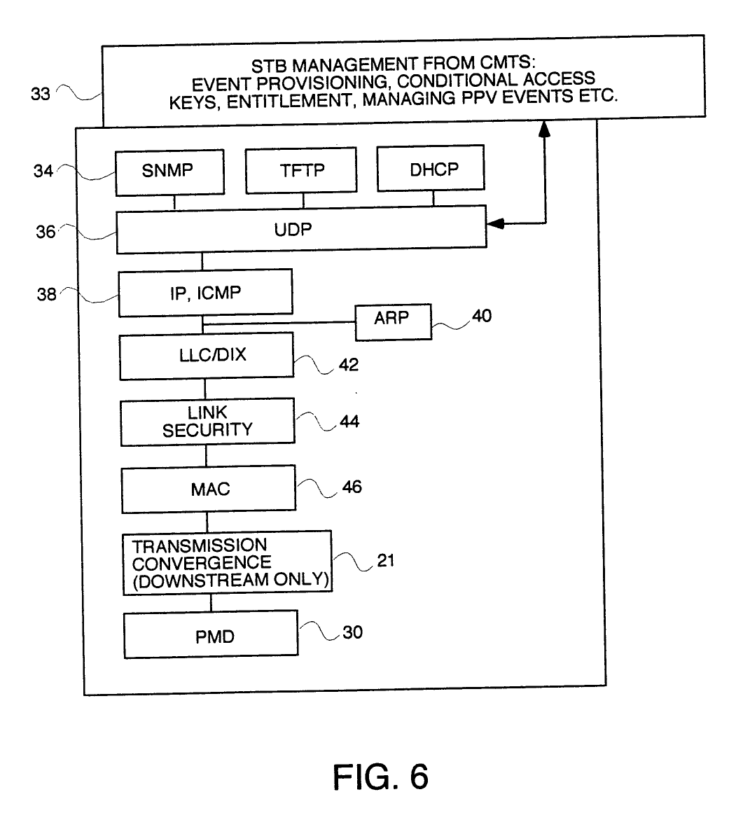

FIG. 6 is a more detailed diagram of the DOCSIS communication protocol stack on the RF interface to the HFC that comprise blocks 20, 21 and 30 in FIG. 5. DOCSIS requires these protocols (except for the highest layer protocol 33) to be used to allow Internet Protocol (IP) packets to be transmitted transparently between the headend and the cable modems. The DOCSIS system is therefore transparent as a transport mechanism to the IP packet source and any customer premise equipment coupled to a cable modem (CM) or STB at the customer premises end or coupled to the Cable Modem Termination System (CMTS) at the head end.

Both CM and CMTS act as IP hosts which must support IP over DIX link-layer framing and may support IP over SNAP framing. The CMTS may act as a transparent bridge or may employ network layer forwarding such as routing and IP switching. Certain management functions also ride on the IP such as spectrum management functions and downloading of software. SNMP block 34 represents a network management protocol which allows the head end to gather network management data from the STBs and to send network management data and commands to the STBs to control certain SNMP aspects of their operation remotely from the headend.

UDP layer 36 assembles datagrams, and IP layer 38 adds IP header information including source and destination addresses. This allows specific IP packets to be addressed to specific STBs and specific ports within those STBs. The IP layer then encapsulates the datagrams in the payload portion of IP packets.

Address Resolution Protocol layer 40 resolves IP addresses and maps them to physical addresses. IP networks today are well understood and include all the hooks and tools needed to manage devices coupled to the network so transmission of the M&C data in-band on the DOCSIS PID takes advantage of this fact to prevent the need to re-invent the wheel to manage interactive services via an in-band M&C channel.

Link layer control/DIX layer (LLC) 42 adds header information specified by IEEE 802.2 that identifes the contents of the packet as an IP datagram which is needed when multiplexing multiple protocols (IP and MPEG) on a single virtual circuit. This layer also provides a reliability function for the IP layer to insure all IP packets get to the destination.

The link security layer 44 does conventional DOCSIS functions such as encryption of IP packets.

The MAC layer 46 carries out the part of the DOCSIS protocol which governs access to the physical media independent of the physical characteristics of the medium but taking into account the topological aspects of the subnetworks in order to exchange data between nodes. MAC procedures include framing, ranging, error control and acquiring the right to use the shared medium. The MAC layer uses the services of the physical layer 30 to provide services to the LLC layer 42.

The Transmission Convergence layer provides an interface between the data link layer and the PMD layer 30 to take DOCSIS MAC frames containing M&C data formerly sent over an OOB channel and encapsulate this data into MPEG-2 packets of transport streams having the DOCSIS PID in the header. Other types of data such as digital video data or any other digital service data can also be encapsulated into MPEG packets in this layer and sent as private data.

The PMD or physical media dependent layer 30 takes the MPEG packets, breaks them up into symbols and does forward error correction functions and transmits the symbols, as previously described.

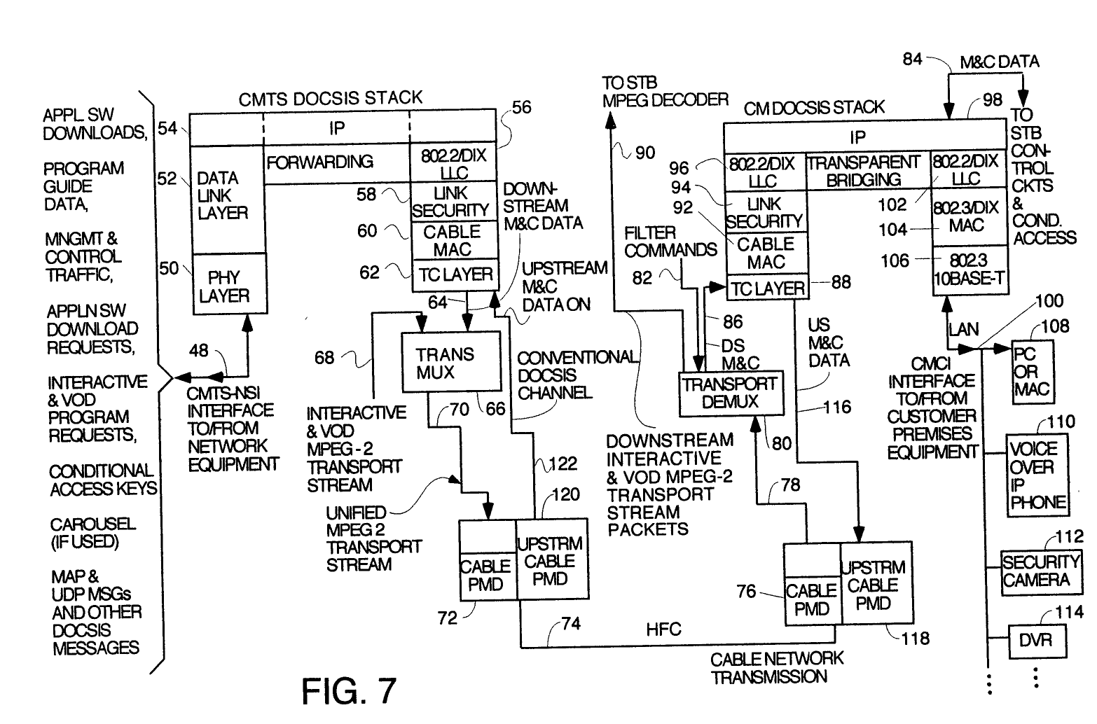

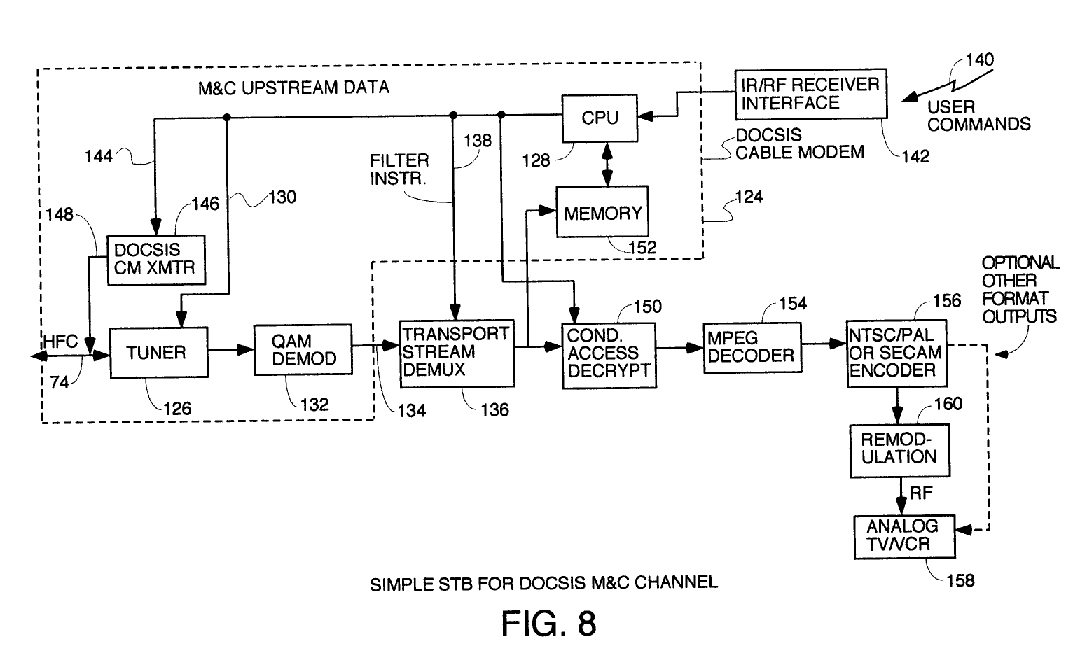

FIG. 7 is a more detailed block diagram showing the protocol stacks for the upstream and downstream M&C in-band channel and services delivery at both the CMTS and CM ends. The protocol stack on the left is at the CMTS, while the protocol stack on the right is at the CM. This diagram shows how the M&C data and the interactive services and video-on-demand data are merged into a combined MPEG-2 transport stream or multiplex (more than one transport stream) and sent to the physical media dependent (PMD) layer and transmitted over the HFC. The bidirectional stream of M&C data is the stream of data on line 48. Line 48 carries both upstream and downstream M&C data, and is coupled to a server(s) at the head end which generates the downstream M&C data and uses upstream M&C data. The M&C data on line 48 can include requested application software downloads addressed to specific STBs, requested program guide data addressed to specific STBs, requests for specified program guide data from STBs, requests for specific application software from STBs, requests for conditional access keys from STBs, conditional access keys addressed to specific STBs, pay-per-view event purchase information from STBs, event provisioning data, software upgrades and bug fixes to specific STBs, etc.

Phy layer 50 interfaces the DOCSIS protocol services with these servers using whatever physical interface and media the servers use to transfer data via data path 48.

Data link layer 52 performs services to allow transmission of the raw data coming from the PHY layer over a data path to the CMs which appears to the servers coupled to line 48 to be free of transmission errors. It does this by breaking the data into frames, transmitting the frames sequentially and processing acknowledgement frames coming back from the CMs on the DOCSIS upstream. The data link layer 52 provides services to create and recognize frame boundaries such as by attaching special bit patterns to the beginning and/or end of each frame. This layer also provides services to handle lost or damaged frames and flow control issues.

IP layer 54 encapsulate the M&C data frames received from the data link layer into IP packets, and provides IP addressing information in the headers to address downstream M&C data to specific STBs. The IP packets are then forwarded to the 802.2/DIX/LLC layer 56.

LLC Layer 56 assembles the data link layer frames for transmission. Link security layer 58 provides security services such as encryption.

The MAC layer implements the DOCSIS MAC layer protocols such as sending timestamps in synchronization and UCD messages, sending ranging request messages, obtaining time, frequency, phase and power offsets from the receiver hardware circuitry that makes these measurements on the preambles of ranging bursts, sending ranging response messages that include time, phase, frequency and power offset adjustments to STB cable modems that have transmitted ranging bursts, receiving bandwidth request messages during contention intervals, sending MAP messages allocating the DOCSIS upstream minislots among the STB cable modems that have requested bandwidth, sending UCD messages which define the channel characteristics of one or more logical channels in the DOCSIS upstream, etc. The MAP messages contain information elements that define initial station maintenance intervals which are contention regions when STB cable modems can send their ranging requests. The MAP messages also define request contention areas during which STBs which need upstream bandwidth can send upstream messages requesting grants. The MAP messages also include information elements that define grants for specific STBs in terms of the SIDs assigned to the STB cable modem. These grants are transmit opportunities during which the STB can transmit upstream M&C data or other messages using its cable modem. The MAC layer 60 generates downstream MAC frames and receives upstream MAC frames and processes them. The DOCSIS MAC protocols are well understood and no further discussion of them is needed here.

The downstream MAC frames are output to a transmission convergence layer 62 which encapsulates the MAC frames in MPEG-2 packets.

The MPEG-2 packets with M&C data are output on line 64 to a transport stream multiplexer 66. MPEG-2 packets in a transport stream containing compressed video, audio and other data for video-on-demand, interactive services, broadband internet access, voice-over-IP arrive on line 68 from the servers which provide these services. The transport stream multiplexer combines all these MPEG-2 packets into an MPEG multiplex comprised of several transport streams and generates the MPEG-2 packets containing the PAT and PMT tables. The combined multiplex is output on line 70 to a physical media dependent layer 72. Generally, the PMD layer 72 does forward error correction processing on the data on line 70. Depending upon the characteristics of the DOCSIS PID downstream channel and the particular PMD layer characteristics, that processing can vary and some characteristics of the forward error correction processing such as interleaving depth, Reed Solomon block size, Trellis encoding on or off can vary from one embodiment to the next or be programmable. In the case of a DOCSIS 2.0 downstream, the PMD layer 72 breaks the MPEG multiplex into Reed Solomon coding blocks of programmable block size, encodes them with error correction data, interleaves them if interleaving is turned on, and scrambles them is scrambling is turned on, breaks the stream of bits into symbols and Trellis encodes them if Trellis encoding is turned on, and QAM modulates them into RF signals on HFC 74.

At the STB, a DOCSIS compatible cable modem tuner tunes and demodulates the MPEG multiplex and provides the recovered bit stream for signal processing to the PMD layer 76. The PMD layer 76 recovers the MPEG-2 packet stream of the multiplex by doing the reverse processing to that performed by PMD layer 72.

The recovered MPEG-2 packet stream is output on line 78 to a transport demultiplexer 80. Demultiplexer 80 receives filter commands on line 82 from a programmed microprocessor (not shown) in the STB. The microprocessor in the STB executes a navigation program (which is resident on the STB in the preferred embodiment) which receives user inputs regarding which channels the user wishes to tune, what pay per view events the user want to order, what program guide data the user wants to see, what interactive services the user want to participate in, what video-on-demand movies the user wishes to view, etc. This data is converted into upstream M&C message data on line 84 and filter commands on line 82. The filter commands tell the transport demultiplexer 80 which MPEG-2 packets to extract from the MPEG-2 multiplex by PID.

The microprocessor derives these PIDs from examination of the PMT table. To obtain these filter instructions, the transport stream demultiplexer 80 first filters out packets with PID 0. These packets contain the MPEG-2 program association table that defines which transport streams are in the multiplex. Next, the transport demultiplexer selects the transport stream which carries the requested services and extracts the packets containing the program map PID. These packets are processed to obtain the program map table (PMT) which defines which PIDs are associated with each delivered service. The packets with the PID(s) of the requested service(s), are extracted from the MPEG multiplex and supplied on line 90 to the conditional access circuitry (not shown) for decryption and thence to the MPEG video and audio decoder for generation of NTSC signals.

MPEG-2 packets with the DOCSIS PID are extracted and supplied on line 86 to the transmission convergence layer 88. There, the MAC frames encapsulated in the MPEG-2 packets are recovered. The MAC frames are passed to MAC protocol process 92 where the MAC frames are processed and any downstream messages from the CMTS are recovered and acted upon in conventional DOCSIS fashion and passes the data recovered from the MAC frames to the link security layer 94.

Link security layer 94 decrypts data received from the MAC layer and passes the decrypted data to LLC layer 96. The LLC layer dissembles the frames assembled by data link layer 52 on the CMTS side to recover IP packets, and passes the IP packets to the IP layer 98. The IP layer routes the IP packets by resolving their IP addresses to physical addresses and sending the M&C data on line 84 to the appropriate STB control circuits (not shown) such as the conditional access circuits, the microprocessor, etc. More about which types of M&C data are sent to the various STB circuits will be said in connection with description of the simplified STB. The M&C data includes the PMT table data which gets routed to the STB microprocessor. The microprocessor compares the data it has retained about the interactive services, video-on-demand and other services which the user has ordered to the PID data in the PMT table to determine which PIDs the MPEG-2 packets containing the data of each ordered service will contain. These PIDs are used to generate the filter commands on line 82 to the transport demultiplexer 80 so it can extract the MPEG packets containing the ordered services.

Upstream M&C data (such as requests for services, download of particular application programs or particular program guide data or requests for decryption keys for particular services) is sent from the STB control circuits via data path 84 to the IP layer 98 and encapsulated in IP packets addressed to the server at the headend handling the M&C data. The IP packets then pass down through layers 96, 94, 92, 88 and are passed as MPEG-2 packets on line 116 to an upstream cable physical media dependent layer 118 for forward error correction and transmission upstream on HFC as a conventional DOCSIS QAM modulated RF signal.

At the headend, an upstream cable physical media dependent layer 120 receives and demodulates the QAM signal and recovers the MPEG packets therein and passes them on line 122 to the transmission convergence layer 62. The TC layer 62 recovers the MAC frames in the MPEG packets on line 122 and passes the MAC frames to MAC protocol layer 60 where the MAC frames are processed. For example, upstream ranging bursts have measurements made for timing offset, phase and frequency offset and power offset. The results for each STB's cable modem are put into a downstream MAC message called a ranging response message. This message is sent to the STB and used by the DOCSIS modem transmitter circuitry therein to make adjustments to get into synchronization with the DOCSIS upstream. Upstream M&C data is passed by the MAC layer 60 through the link security layer 58 and the LLC layer 56 to the IP layer 54, all of which do conventional DOCSIS processing on the data. The IP layer 54 routes the upstream M&C data down through data link layer 52 and PHY layer 50 for transmission on data path 48 to the server which is handling upstream M&C data.

Returning to consideration of the STB, any downstream IP packets containing data for typical DOCSIS services such as broadband internet access, voice-over-IP, etc. that need to be routed to a personal computer or other device coupled to the STB are routed down to a local area network interface 100. This is done by the IP layer 98 passing these IP packets to an LLC layer protocol 102 which does conventional DOCSIS processing and passes the resulting frames to MAC layer protocol 104 which generates MAC frames and carries out the required protocols to access the local area network 100. The resulting MAC frames are delivered to a LAN physical layer interface 106, which in the illustrated embodiment, is an 802.3 10Base-T Ethernet interface. There the MAC frames are encapsulated in Ethernet frames and the MAC addresses are resolved to physical addresses on the LAN and sent to the appropriate device coupled to the LAN such as PC 108, voice-over-IP phone 110, security camera 112, digital video recorder (for video-over-IP services) 114, etc. Upstream data from these devices, if any, takes the reverse path up through the layer 106, 104 and 102 protocols and is addressed by the IP layer 98 to whatever server at the headend is handling the particular service to which the upstream data belongs. From there, the upstream service data takes the same path and has the same processing as the upstream M&C data until it gets to the PHY layer protocol 50 at the headend. There it is routed to whatever server at the head end is handling the particular service to which each packet pertains.

Simple Set Top Box with Single Tuner for use with DOCSIS in-band M&C Channel

Referring to FIG. 8, there is shown a block diagram of a simple set top box with a single tuner for receiving interactive and VOD data and other services along with a DOCSIS in-band management and control channel to manage the STB and the delivered services. HFC 74 is coupled to a tuner 126 which is part of a conventional DOCSIS cable modem 124 which has been modified to perform the additional functions identified herein. The tuner tunes to the MPEG multiplex carrier frequency. In some embodiments, that frequency can be fixed. In other embodiments, the tuner is frequency nimble and tunes to whatever frequency the head end tells the STB to tune by way of a downstream message on the DOCSIS PID. This message is routed to microprocessor 128 which sends tuning commands to tuner 126 via line 130. The tuner demodulates the multiplex signal and filters out unwanted RF signals outside the bandwidth of the MPEG-2 multiplex signal. Any DOCSIS compatible cable modem tuner can be use. Typically, the tuner will have an automatic gain control (AGC) amplifier which has its gain controlled by the microprocessor. The AGC amplifier will drive a bandpass filter with a broad passband which filters out RF signals outside the band that the downstream MPEG multiplex is in. The bandpass filter feeds the filtered MPEG multiplex RF signal to a mixer which mixes it with a frequency nimble local oscillator signal which has its frequency controlled by microprocessor 128 so as to mix the signal down to an intermediate frequency (IF) signal. The IF signal is then filtered in a narrow passband filter having a passband bandwidth which is set to equal the bandwidth of the IF signal. Finally, an analog-to-digital converter samples the signal at a rate sufficiently fast to satisfy the Nyquist criteria so as to output a stream of samples. In some embodiments, this stream of samples is processed by known narrow band excision circuitry to remove samples which may be corrupted by narrow band interference.

The filtered samples are output to a QAM demodulator 132 which functions to recover the MPEG-2 packets from the received constellation points. Any conventional DOCSIS modem QAM demodulator circuitry which can recover the MPEG-2 packets from the received constellation points will suffice. In some embodiments, the QAM demodulator will include a programmable despreader that can be turned on or off depending upon the downstream channel UCD message parameter that indicates whether spectrum spreading is on or off. The despreader functions to despread spread spectrum downstream bursts. In some embodiments, the QAM demodulator also includes a programmable code hopper to track code hopping in the downstream channel when the UCD message indicates code hopping is active on the downstream DOCSIS PID channel. However, in the preferred embodiment, spread spectrum downstream bursts are not allowed on the downstream DOCSIS channel, so the QAM demodulator just includes the circuitry needed to demodulate a non spread spectrum digitized QAM signal. Typically, this circuitry includes the circuitry needed to undo the forward error correction processing done by the downstream PMD layer at the headend. Typically, this would include a sample buffer, a downstream symbol clock recovery circuit which synchronizes a local oscillator symbol clock to the recovered downstream symbol clock, an equalizer filte, a programmable Viterbi decoder to detect the data bits in each received constellation point, circuitry to reassemble the Reed Solomon (RS) blocks, deinterleave them and error correct them using the error detection and correction bits in each block, and a Transmission Control layer interface to reassemble the MPEG-2 packets from the decoded RS blocks.

The MPEG-2 packets of the multiplex are output on line 134 to transport stream demultiplexer 136. This demultiplexer receives filter instructions on line 138 from the microprocessor 128 that indicate the PIDs of the program elementary stream(s) (PES) that carry the compressed data of the digital video broadcast, interactive services, video-on-demand and other services the user has ordered. The microprocessor 128 knows what services the user has ordered by virtue of monitoring the navigation commands the user has entered via the remote control and infrared or RF commands 140 received by IR/RF receiver interface 142. These commands are sent to the microprocessor 128 which converts them to upstream M&C request data on data path 144 and to filter commands on data path 138. The upstream M&C data is transmitted upstream on the conventional DOCSIS upstream 148 by a DOCSIS cable modem transmitter 146. The transport stream demultiplexer 136 responds to the filter commands by filtering out the MPEG-2 packets containing the ordered services and sending them to conditional access circuit 150. The demultiplexer 136 also filters out MPEG packets with PID 0 containing the PAT table and stores them in memory 152 for use by microprocessor 128 in determining which transport streams are in the received MPEG-2 multiplex. The microprocessor 128 then processes the PAT table to determine the PID of the PMT table for the transport stream containing the MPEG-2 packets carrying the data of the requested services. The microprocessor then sends filter commands to the transport stream demultiplexer 136 requesting it to extract the MPEG-2 packets containing the PMT table and load them in memory 152. Once this is done, the microprocessor compares the data it has stored regarding the requested services to the PIDs in the PMT table and determines which PIDs the requested services will be on. Suitable filter commands are then generated and sent to transport stream demultiplexer 136 to cause it to extract the packets of the ordered services for routing to the conditional access decryption circuit 150.

The STB of FIG. 8 can use the prior art method of conditional access described in the “Open Cable Architecture” book incorporated by reference herein. Alternatively, the STB can use the DOCSIS key exchange protocol, or it can use the the less-bandwidth-intensive, ask-and-receive conditional access method described later herein. In this ask-and-receive protocol, the prior art data carousel is eliminated and only the keys needed by a particular STB for a particular service are requested and are sent in-band on the DOCSIS PID as an EMM message and an ECM message. The difference of the ask-and-receive protocol over the prior art is there is no data carousel on an OOB channel which contains all the EMMs and ECMs for all services. Only the keys that are needed are sent, and they are not sent on an OOB channel. More details about the ask-and-receive protocol are given below under the Conditional Access Protocol heading

The filter commands generated by the microprocessor 128 cause the transport stream demultiplexer 136 to filter out MPEG-2 packets which contain the decryption keys in Entitlement Management Messages (EMM) and Entitlement Control Messages (ECM) which are needed to decrypt the payload data of any packets of encrypted services such as pay-per-view events, VOD, etc. If the prior art method of conditional access is used in an alternative embodiment, conditional access circuit 150 is a secure microprocessor and a payload decryption engine, both mounted in a smart card so that they can be removed and replaced in case of a breach in security. In other embodiments, the conditional access circuit is a permanent circuit in the STB. In the prior art method, the filter commands cause EMM messages to be filtered out from the DOCSIS PID in the MPEG-2 multiplex, and sent to the secure microprocessor 150 which decrypts them to recover a session key. The filter commands also cause ECM messages to be filtered out from the DOCSIS PID in the MPEG-2 multiplex and sent to the secure microprocessor 150 for decryption using the session key to recover a working key. The working key is then sent to the payload decryption engine along with the MPEG-2 packets containing the data of the encrypted services. The encrypted payload sections are decrypted using the working key, and the resulting data is sent to an MPEG decoder 154 for decompression. The decompressed data is sent to an NTSC/PAL/SECAM encoder to generate an analog television signal suitable for the country in which the system is operated and the type of television/VCR 158 the STB is coupled to. The analog television signal is supplied to a remodulation circuit 160 to modulate the television signal onto an RF carrier having the frequency of channel 3 or channel 4. In some embodiments, the encoder 156 also outputs composite video and audio signals on an RCA jack interface or component output signals also on an RCA jack interface or S-Video signals at an S-Video jack or an AC-3 signal, or all or some subset of the above other format outputs.

The microprocessor 128 executes a resident navigation program and operating system stored in memory 152 to respond to user commands. The microprocessor generate upstream requests to download just the application software needed to process each request and requests downloading of only the conditional access key(s) needed to decrypt the packets containing the data of the ordered service(s). If the user has requested program guide data, the microprocessor 128 is programmed to generate an upstream M&C request to request only the desired program guide data and not the entire program guide. In some embodiments, the microprocessor may also generate upstream requests to also download program guide data for neighboring channels to the channel for which a user request was received so that the user can see what other programs and services are available on neighboring channels at around the current time or some user specified time. The microprocessor 128 also executes a loader process which is resident in memory 152 which functions to receive MPEG packets carrying application software to execute services the user ordered, assemble the packets into a computer program, load the computer program in memory 152 and launch it in time to process the incoming MPEG-2 packets of the service. The head end is responsible for sending the application software for an ordered service on the DOCSIS PID sufficient far ahead of the time the service data itself is sent downstream to give the loader time to load and launch the application software for the service.

Memory 152 stores programs for execution by microprocessor 128 which implement the DOCSIS protocols such as those shown in FIG. 7 on the cable modem side. The downstream PMD layer functionality is implemented in DOCSIS transmitter circuitry 146. Memory 152 also stores programs to control the STB such as implement the user interface, navigate, implement an operating system, receiver user commands and generate upstream requests for services, keys and application program downloads, as well as a loader program described below.

In some embodiments, the microprocessor 128 is programmed to execute an agent program that keeps a running tally of the programs and services the user views or uses and either sends this data as upstream M&C data periodically or waits for the headend to request it. This allows the head end circuitry to generate and send downstream to the appropriate STBs targeted advertising messages selected according to the viewer's tastes and preferences.

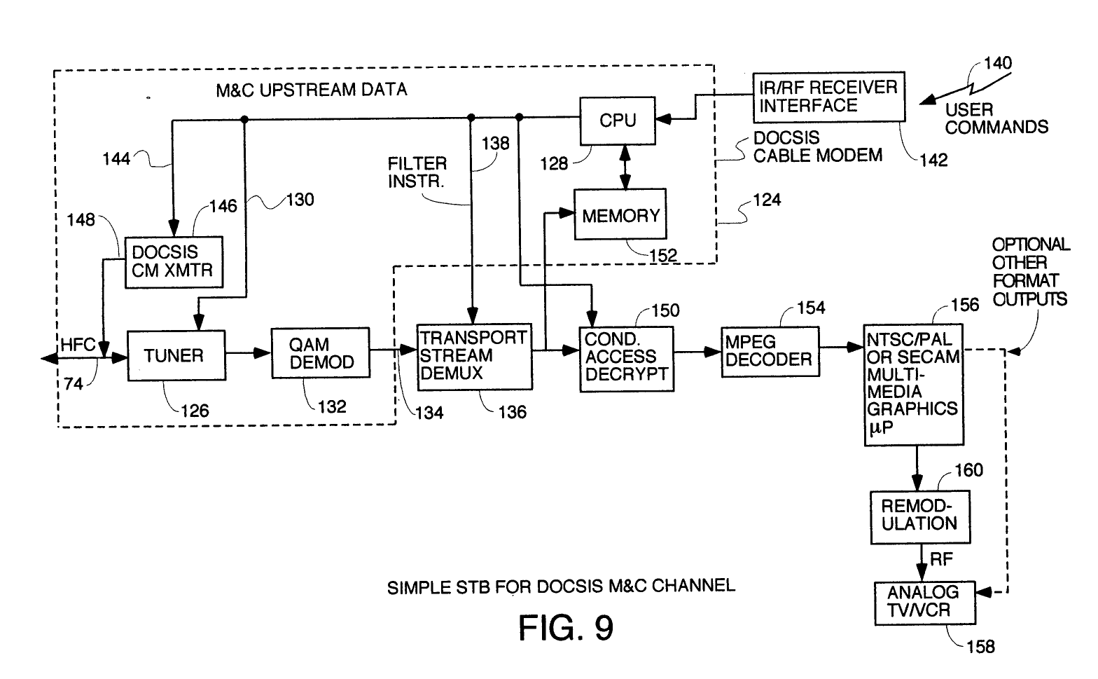

FIG. 9 represents an alternative embodiment of a single tuner STB where the NTSC/PAL/SECAM encoder 156 is a multimedia graphics processor which genererates an analog television signal of the proper format and overlays graphics on the displayed images to display program guide data, navigation information, and whatever other graphics information is needed. Such graphics processors are currently used in STBs of DBS and cable systems.

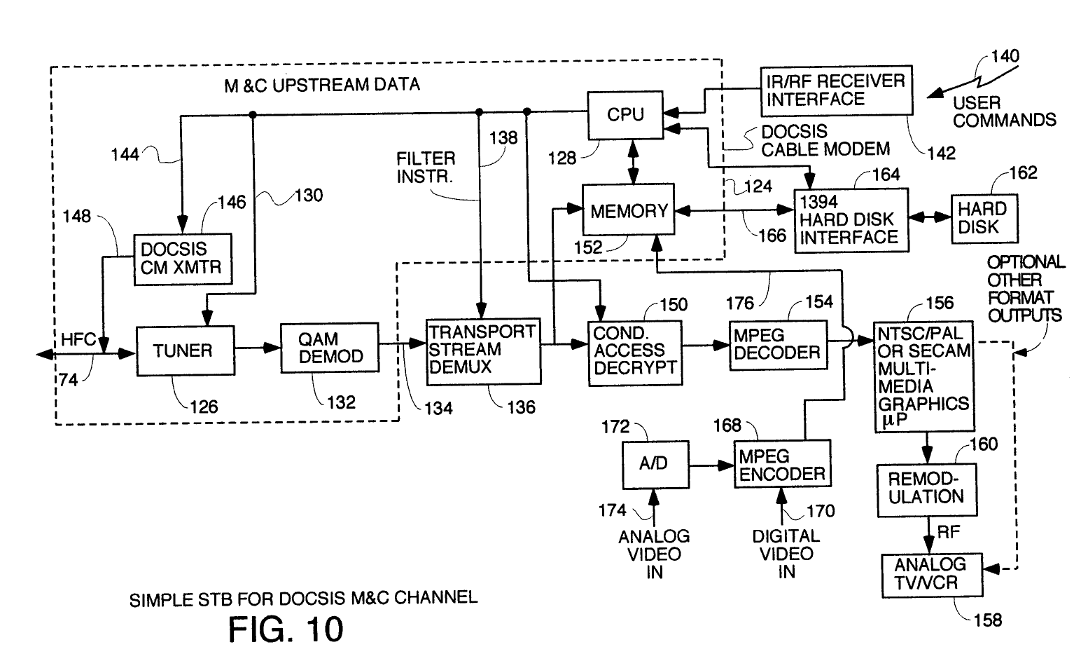

FIG. 10 represents an alternative embodiment of a single tuner STB with TIVO type digital video recording capability. In this embodiment, memory 152 stores, in addition to the programs described above, a digital video recording program which microprocessor 128 executes to control a hard disk 162 using a hard disk controller IEEE 1394 interface 164. This embodiment allows users to: enter requests to get season passes to record certain shows; search program guide data for shows by title or any other criteria; browse the program guide and select programs to record; manually enter times and channels to record; automatically learn the user's preferences or let the user teach the digital video recorder her preferences through thumbs up and thumbs down button pushes and automatically record shows the user may find interesting; playback of recorded programs using normal and multispeed fast forward and fast reverse; slow motion; stop action freeze frame; pause live TV; record live TV as it is watched and allow rewind; as well as all the other functions of TIVO and other known digital video recorders. Other features include showcases previews of coming attractions, viewer magazines, etc. Data is recorded by the microprocessor by performing the following steps: generating upstream M&C messages requesting program guide data or a VOD menu; receiving a user command to record a broadcast program or VOD program or receiving an automatically generated request to record a certain program via season pass function or a TIVO preferences selection function; converting that request into upstream M&C message requesting download of the VOD program and its conditional access key(s) or, at the designated time of the broadcast to be recorded, generating M&C upstream messages requesting download of the conditional access keys and generating filter commands to the transport demultiplexer instructing it to extract the MPEG-2 packets of the requested VOD program or digital video broadcast to be recorded; receiving those MPEG-2 packets in memory and transferring them through hard disk interface 164 to hard disk 162 where they are stored along with the MPEG-2 packets sent on the DOCSIS PID containing the conditional access key(s) for the program. Program guide auxiliary data containing, for example, the title, rating, actors and a plot summary along with channel and time and date recorded information may also be stored with the program data. Programs are played back by the digital video recorder by the microprocessor 128 performing the following steps: receiving a request from a user to display a list of programs recorded on hard disk 162; receiving a user request to play a specified program; sending a command to the hard disk interface 164 requesting fetch of the MPEG-2 packets of the program; retrieving the packet data from the hard disk 162 and storing them in memory 152 via data path 166; retrieving the MPEG-2 packets containing the conditional access key(s) and storing them in memory 152; sending the packets containing conditional access key(s) to conditional access decryption circuit 150 for description and recovery of a working key; sending the MPEG-2 packets of the program to the conditional access circuit 150 for decryption; sending the decrypted data to MPEG decoder 154 for decompression; and sending the decompressed data for video, audio and any associated graphics to encoder 156 for generation of analog television signals of any type for display. Special effects such as multispeed forward or reverse, pause, slow motion, etc. are all implemented in the same way these functions are implemented in a TIVO or similar digital video recorder. Other functions such as deleting or changing the save until date or changing the quality of the recording are done in the same way they are done in TIVO or other prior art digital video recorders.

The embodiment of FIG. 10 also has a video recording feature which allows analog or digital video from any source to be recorded and played back on the STB digital video recorder. Digital video in from any source arrives on line 170 and is compressed and encapsulated in MPEG-2 packets in MPEG encoder 168. These packets are loaded into memory 152 by the microprocessor 128 which executes an interrupt service routine when it receives an interrupt that a packet is ready or which polls the MPEG encoder periodically to upload any packets it has prepared into memory via data path 176. Analog video arriving on line 174 is digitized in analog-to-digital converter 172 and loaded into MPEG encoder 168 for compression and encapsulation into MPEG-2 packets. These packets are also loaded into memory 152 by the same mechanism. The microprocessor 128 then sends suitable commands to the hard disk interface 164 to cause the MPEG-2 packets containing external video to be recorded on the hard disk. Playback is by the same mechanism previously described.

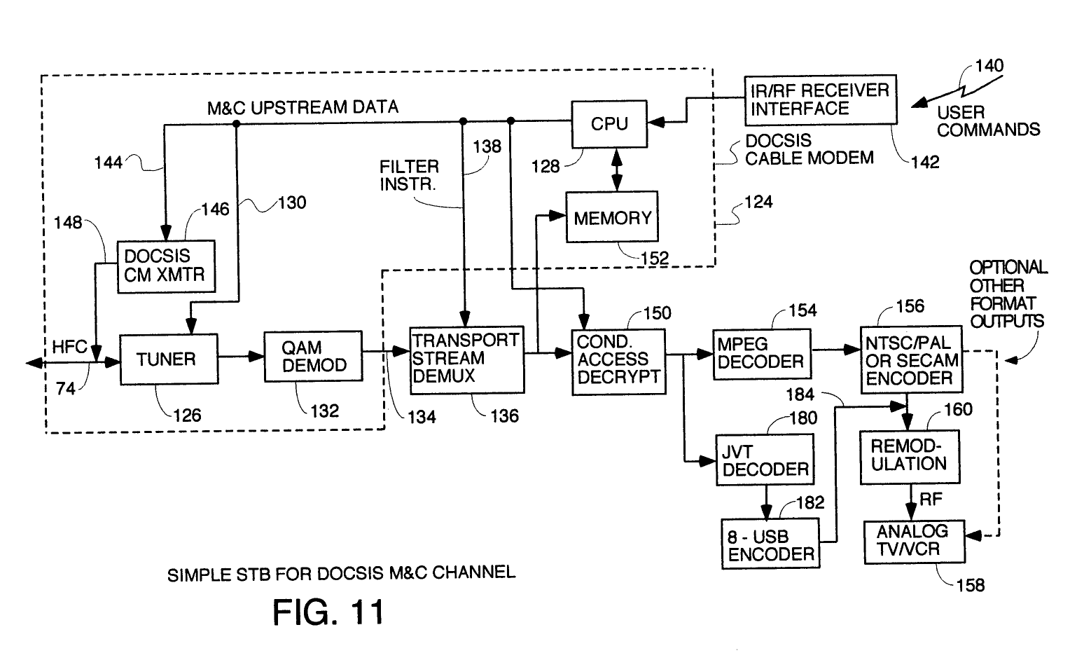

FIG. 11 is a block diagram of another embodiment for a single tuner STB which can receive JVT compressed data or MPEG compressed data. The JVT compression standard is used to compress high definition television signals. Incoming JVT packets are extracted by transport demultiplexer 136 and sent to the conditional access decryption circuit 150. Decryption occurs there in any of the ways done in the prior or described herein. The decrypted packets are then sent to JVT decoder 180 where they are decompressed. The resulting data is then sent to an 8-VSB encoder 182 which generates an analog non interlaced scan high definition television signal which is output on line 184 to the remodulation circuit 160. The encoder 182 may also generate component output signals and other format output signals suitable for high definition television as was the case for encoder 156. This embodiment may have alternative embodiments also such as the addition of any combination of the components that distinguish the embodiments of FIGS. 9, 10, 11 or 12.

Conditional Access Protocol

Various conditional access mechanisms which can be used by the conditional access circuits 150 will be summarized. The program elementary stream of a service in an MPEG-2 multiplex is scrambled using control words also called service keys which are randomly generated and periodically modified. The control words are encrypted using session keys and sent over ECM messages to the STBs via the DOCSIS PID in some embodiments but using the PID of the service they pertain in most embodiments. The session key used to encrypt the service keys for a service is encrypted at the headend using the private user key of an STB that requested the service. The private user key is never sent over the DOCSIS PID. The encrypted session key is sent as an EMM addressed to the STB that requested the service via the DOCSIS PID on an as-needed, targeted basis in the preferred embodiment. The STB uses its private user key, which can be hardwired in the STB circuitry or stored on a smart card, to decrypt the session key. The session key is then used to decrypt the control word, and the control word is used to decrypt the MPEG packets containing the service data.

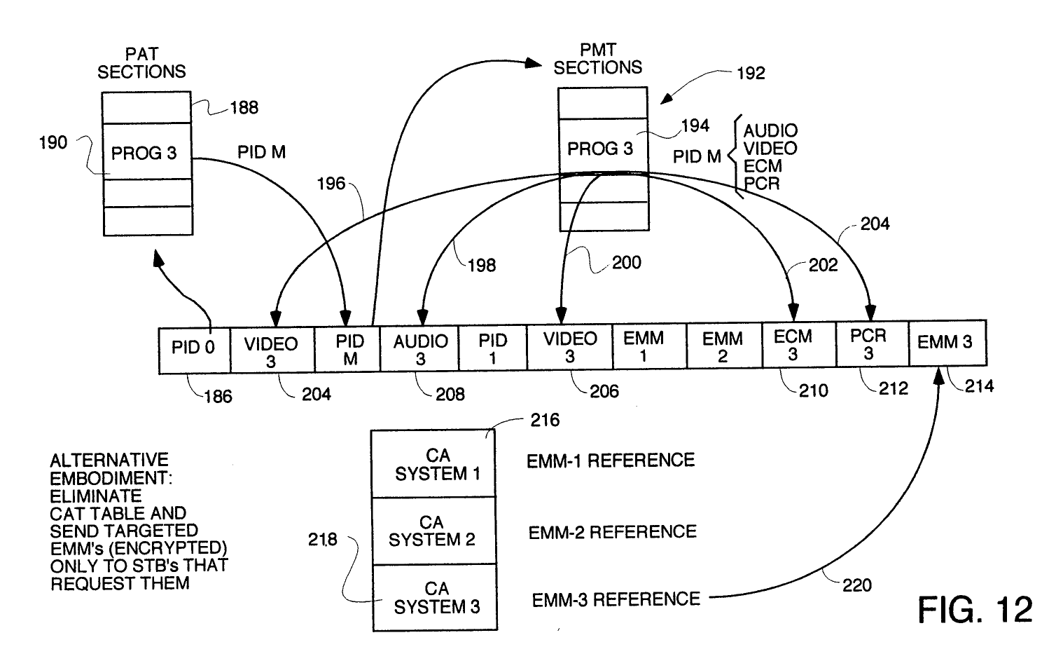

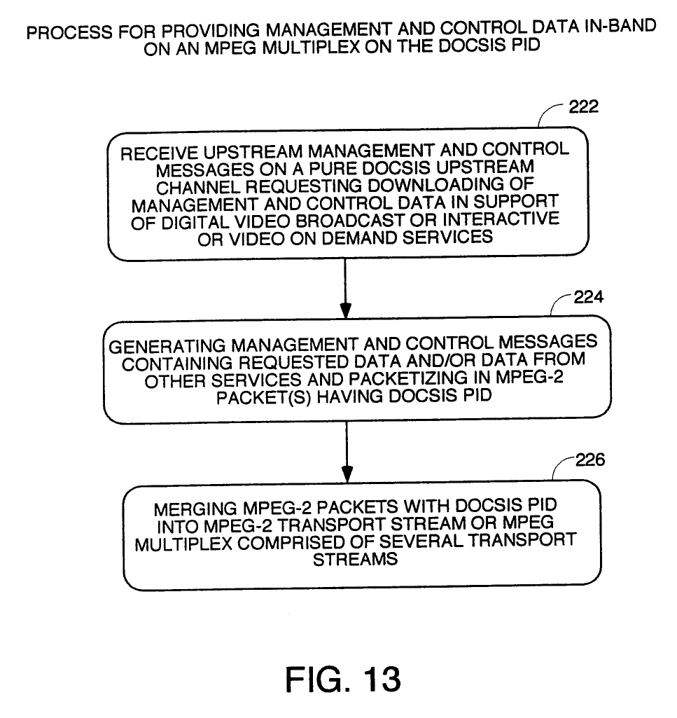

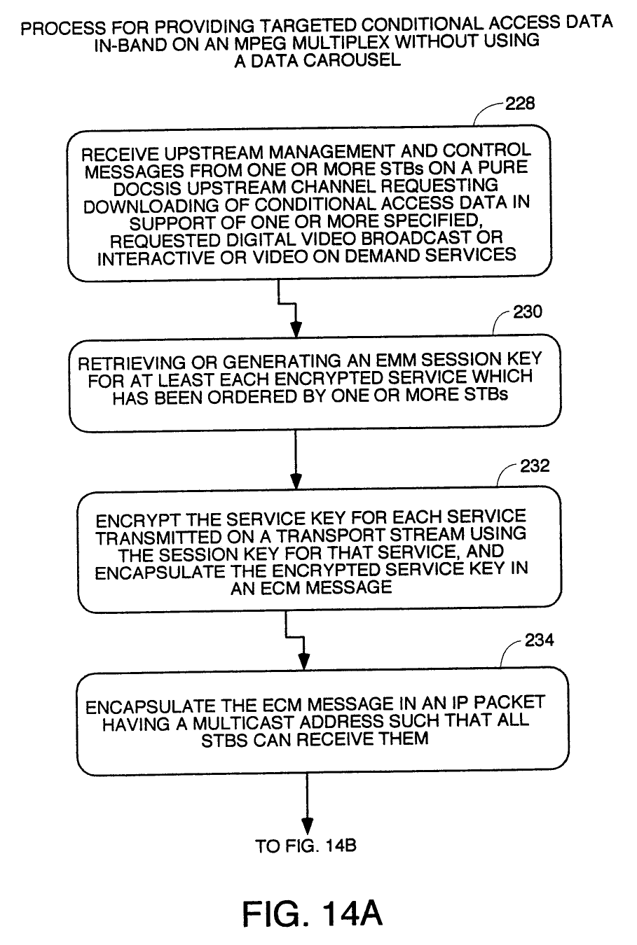

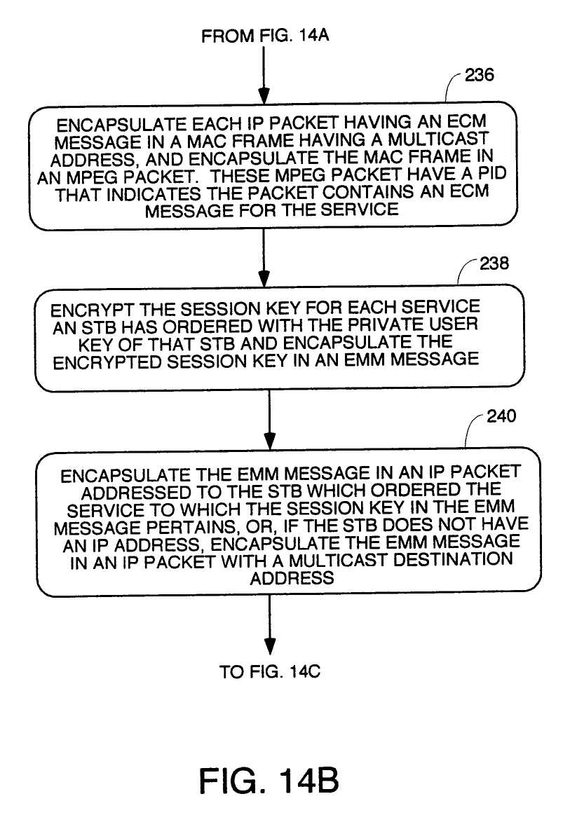

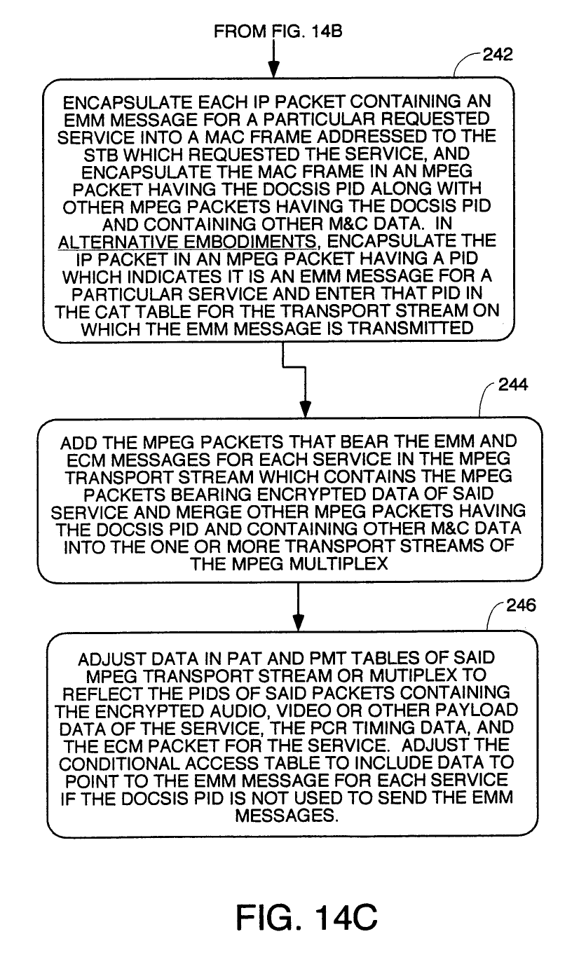

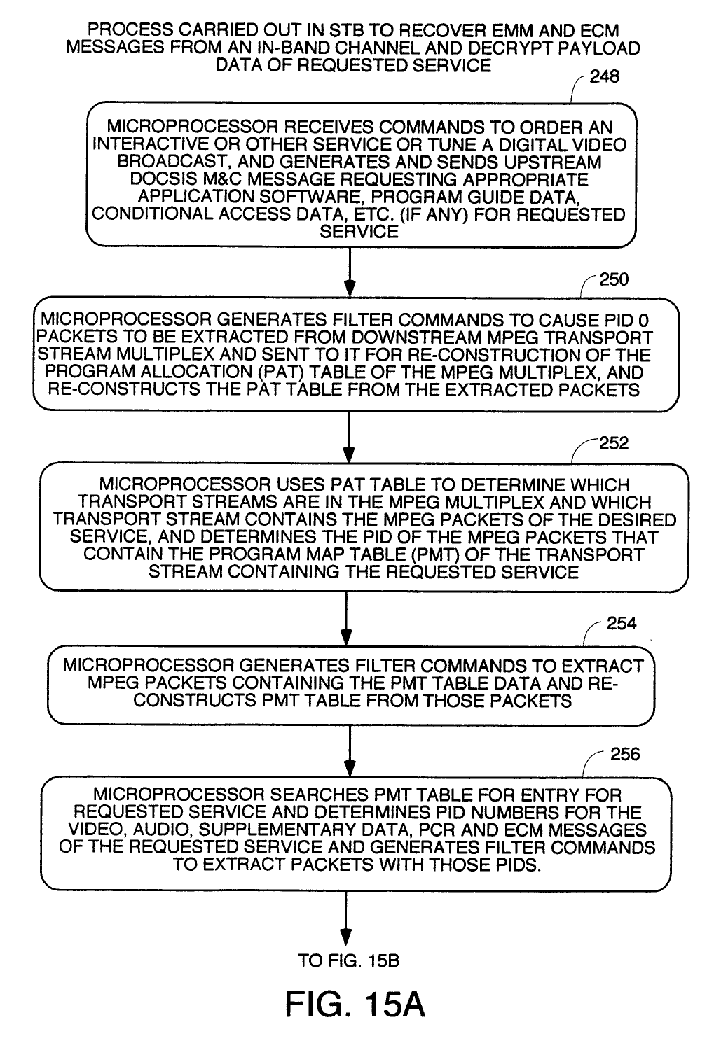

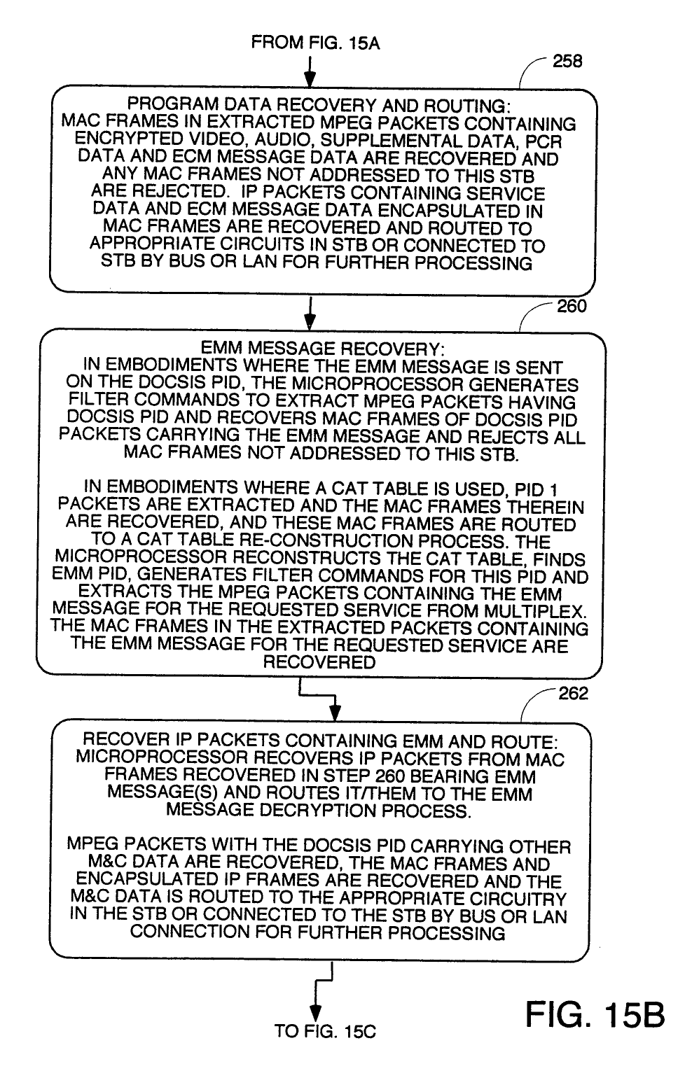

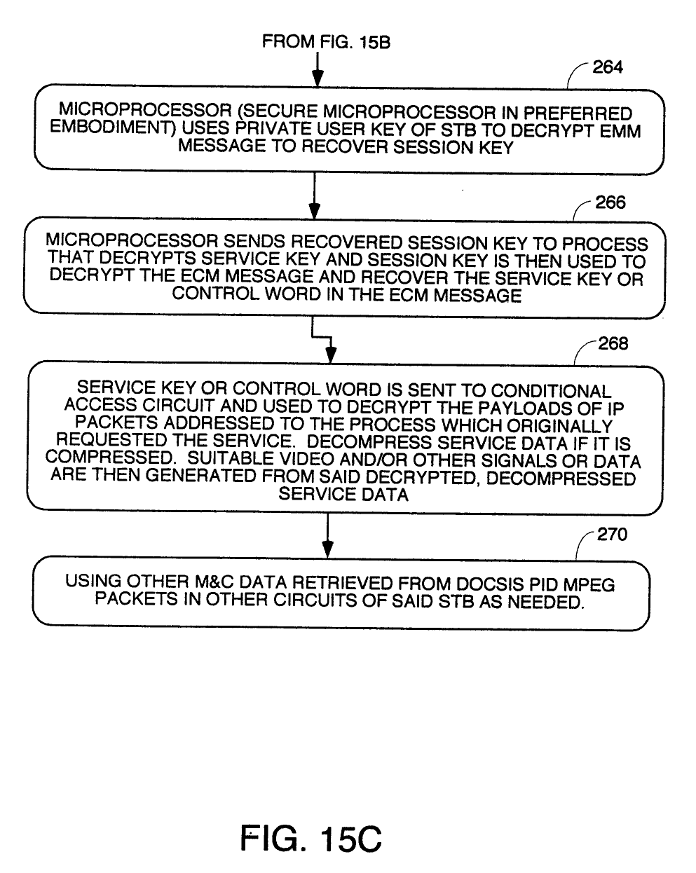

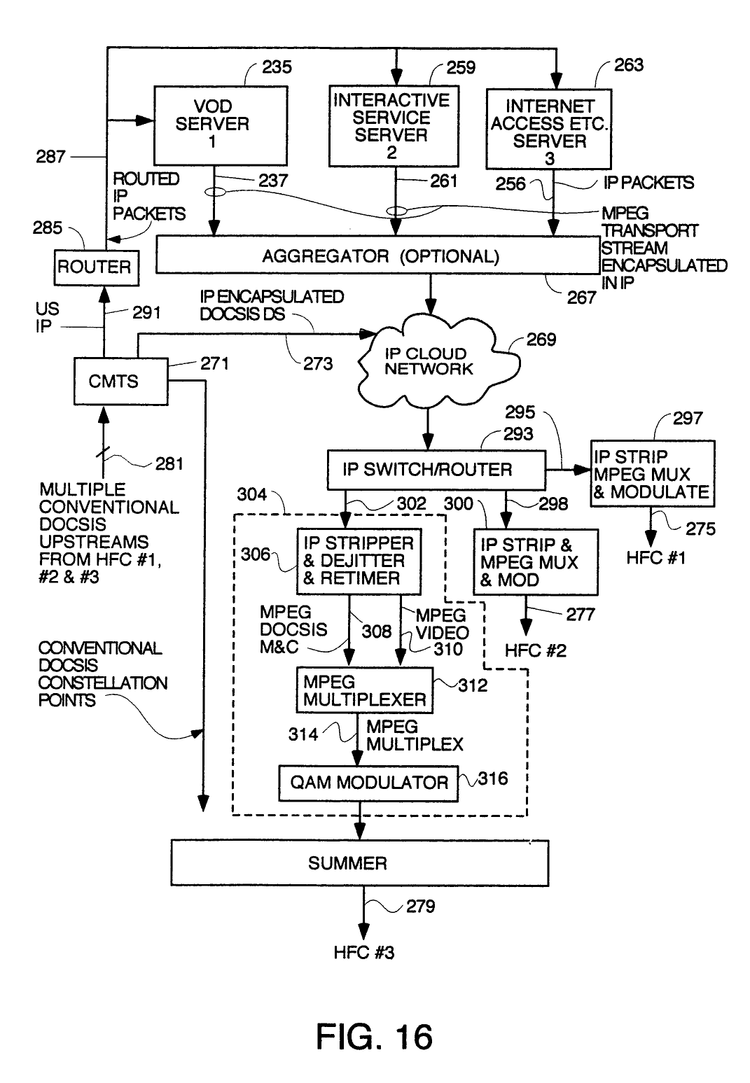

FIG. 12 is a diagram showing how the PID information for a service a user has ordered and the EMMs and ECM messages containing encrypted conditional access keys needed to decrypt the service are found in an MPEG-2 multiplex. FIGS. 14A-14C are a flow diagram showing how the generalized process of FIG. 13 is applied to sending of targeted conditional access data in-band to only the STBs that requested the conditional access data for a particular service. The process of FIGS. 14A through 14C is carried out at the DOCSIS CMTS. The process of FIGS. 15A-15C is carried out in the STB to recover the EMM and ECM messages from the MPEG multiplex when the STB receives a user command to order a certain service or view a specified program. The processes of FIGS. 12, 14, 15 and 16 will be discussed simultaneously and the differences between the processes of FIGS. 14 and 16 will be discussed.

As an overview of the preferred embodiment represented by FIGS. 16A-16C, the ECM service keys will be changed frequently for best security, and will be multicast to all STBs in-band as a data carousel in the MPEG multiplex that contains the MPEG packets bearing the data of the service. The way this works is as follows. The service keys or working keys for each service that can be ordered are encrypted with a session key of each STB and the plurality of encrypted working keys are sent as a data carousel, encapsulated in ECM messages which are encapsulated in multicast IP packets which are encapsulated in multicast MAC frames which are encapsulated in MPEG packets having the PID of the service to which each particular service key pertains. The MPEG packets containing the service key for a particular service have the PIDs for the ECM keys of the corresponding service in some embodiment or the DOCSIS PID or private data PID of the MPEG transport stream on which they are sent. The session keys are generated periodically for each STB or on a per request basis. The session key of each STB is encrypted with the private user key of that STB. In this preferred embodiment, when an STB wants to use a service, it consults the PAT table 188 and the PMT table 192 in FIG. 12 to determine the PID of the ECM messages containing the service keys for the service to be used. The STB then generates filter commands to extract MPEG packets with the ECM message PIDs from the transport stream.

Step 228 in the flowchart of FIGS. 14A through 14C represents the process of the CMTS receiving on the pure DOCSIS upstream from one or more STBs M&C data packets requesting one or more services requested by a user and requesting downstream transmission of conditional access keys for these services and any other M&C data needed such as program guide data, application software to run the service, etc.

Step 230 represents the process of generating or retrieving a session key for each encrypted service or at least the encrypted service(s) ordered by one or more STBs. Each encrypted service has a session key which often contains information regarding which STBs have access rights to decrypt that particular service. The session keys are not unique to each STB but are unique to a particular service and may be changed periodically.

The service key(s) or working key(s) (also known as control words) which are used to encrypt the payload data of each service available on the system are transmitted as an attribute of the encrypted video or other data of every service transmitted on any particular transport stream. The control word of each service is encrypted using the session key of the service.

Step 232 represents the process carried out at the head end of encrypting each control word for a service ordered by an STB using the session key for that service, and putting the encrypted service key in an ECM message.

In step 234, the encrypted control word ECM messages are encyrpted in IP packets having multicast addresses such that all STBs can receive these IP packets.

In step 236, the IP or similar packet generated in step 234 is encapsulated in a MAC frame having a multicast address so that all STBs will receive it. The MAC frame is encapsulated in an MPEG packet. The MAC frames bearing IP packets with ECM messages pertaining to a particular service will be encapsulated in MPEG packets having a PID which indicates the MPEG packet contains the ECM message of a particular service. These MPEG packets will be sent in-band in the transport stream containing the MPEG packets carrying the data of the service to which each ECM message pertains.

In step 238, the session key for each service an STB has ordered is encrypted at the head end with the private user key of the STB which requested the service. The encrypted session key is then encapsulated in an EMM message. The private user key of the STB is known to both the CMTS and the STB, but is never transmitted over the link for security reasons. The user key is stored in nonvolatile memory in the STB, usually in a smart card which is inserted in the STB and which contains a secure microprocessor which does the decryption of the session key and uses it to recover the control word for an ordered service.

In step 240, the EMM message is encapsulated in an IP packet addressed to the IP address of the STB that requested particular service to which the session key in the EMM message pertains. If the STB does not have an IP address, the IP packet will have a multicast destination address.

In step 242, each IP packet containing an EMM message for a requested service is encapsulated into a MAC frame addressed to the MAC address of the STB which requested the service. The MAC frame is then encapsulated in an MPEG packet having the DOCSIS PID. Since the STB knows it requested the conditional access data for a particular service, it will know to which service the EMM message received on the DOCSIS PID pertains. The EMM message also contains data indicating to which service the session key encrypted in the EMM message pertains, so if the STB ordered multiple services and receives multiple EMM messages, it will know to which service each EMM message pertains. In an alternative embodiment, the MPEG packet containing the EMM message is given a PID associated with the particular service requested, and that PID is then entered in the CAT table for the transport stream. In such an embodiment, the PID of the MPEG packet itself containing the EMM message indicates to which service the encrypted session key in the EMM messages pertains. An EMM message having a PID indicated in the CAT table is indicated at 214 in FIG. 12.

In step 244, the MPEG packets bearing the EMM and ECM messages pertaining to a particular service are merged into the one or more MPEG transport streams of the MPEG multiplex carrying the service to which the EMM and ECM messages pertain. Other MPEG packets having the DOCSIS PID and containing other M&C data are also merged into the MPEG transport stream(s).

In step 246, the data in the PAT and PMT tables is adjusted to allow the STBs to find the PIDs for the encrypted video, audio, supplementary data, PCR timing data and the ECM conditional access key data for each requested service. The EMM messages and other M&C data MPEG packets will have the reserved DOCSIS PID so no entry in the PAT or PMT tables is made for them. But in embodiments where the EMM message is sent on a PID that indicates it is an EMM message for a particular service and only other M&C data is sent on the DOCSIS PID, step 246 makes an entry in the CAT table to allow the STBs to find the pertinent EMM message for each service.

We now turn to the process which happens in an STB to recover the data packets and conditional access data for a requested service, as shown in the flowcharts of FIGS. 15A through 15C and the diagram of FIG. 12. Step 248 represents the process in the STB microprocessor of receiving a request from a user to order a service. This can take the form of a request to tune to and display a particular digital broadcast, use an interactive service, request a video-on-demand program, initiate or answer a voice-over-IP telephone call, initiate or answer a video call, request a web page or use any other service. The microprocessor then generates and sends on the pure DOCSIS upstream an M&C message requesting download of the appropriate application software, program guide data and conditional access keys (if any) and other M&C data needed at the STB to provide the requested service to the user.

In order to receive the data of the requested service and decrypt it if it is encrypted, the STB must extract the appropriate packets from the MPEG multiplex. In an MPEG multiplex, MPEG-2 packets having PID 0, of which packet 186 in FIG. 12 is typical, contain the data which defines the program allocation table 188 (PAT). The PAT table defines which transport streams are in the multiplex and which programs/services are on each transport stream. Step 250 represent the process of the microprocessor 128 in the STB generating the appropriate filter commands to cause the MPEG transport stream demultiplexer 136 in each STB to extracts these PID 0 packets and sends them to microprocessor 128 via memory 152. In some alternative embodiments, this happens automatically, and the microprocessor does not have to generate filter commands to cause the PID 0 packets to be extracted.

Step 250 also represents the process of the microprocessor processing these PID 0 packets to recover the PAT table 188. Step 252 is using the PAT table data to determine which transport streams are in the multiplex and which transport stream contains the packets of the requested service. A transport stream is comprised of an assemblage of program elementary streams (PES). For example, the video of a program will be one PES and the audio of the same program will be another PES. The PAT table contains data that allows mapping from the desired program or service to the PIDs of the MPEG-2 packets which contain the program map table (PMT) data which defines the PIDs of the packets which contain the various video, audio, ECM and PCR (timing) data for the desired program or service. Step 252 also represents the process of reading the PAT to determine the PID number of the packets in the transport stream carrying the requested service which carry the program map table data (PMT).

In the example shown, the user has ordered program 3 which has data in block 190 in the PAT table. The data in block 190 identifies PID M as the MPEG packets containing the data that define the program map (PMT) table 192 for the transport stream which contains program 3. Step 254 represents the process wherein the STB generates filter instructions on line 138 in FIGS. 8-11 which tell the MPEG transport stream demultiplexer to extract packets that contain the PMT table. These packets are extracted and sent to microprocessor 128 which extracts the data that defines the PMT table from these packets and re-constructs the PMT table, as represented by step 254.

The microprocessor then searches the PMT table for an entry for the requested service (program 3), as represented by step 256. This entry gives the PIDs for all the packets of the individual PES of program 3 in block 194. Arrows 196, 198, 200, 202 and 204 represent the PID pointers in PMT table block 194 that identify the PIDs of the video, audio, ECM and PCR packets in the transport stream, that taken together, comprise the collection of PES for program 3. The video packets 204 and 206 contain compressed, encrypted video data of the program. The audio packets 208 contain the compressed, and possibly encrypted audio of program 3. The PCR packets 212 contain timestamp data that is used to synchronize the audio and video of program 3. The ECM packets 210 carry the control words or service key encrypted with the session key. The control words are needed to decrypt the payload sections of the video (and possibly audio) packets.

In some embodiments, the EMM messages are sent on the DOCSIS PID or as private data. In alternative embodiments, the EMM messages are sent in-band as part of the transport stream, and a conditional access table (CAT) 216 is included in the MPEG-2 multiplex to point to the EMM messages. The data of the CAT table is contained within MPEG packets having PID 1 (not shown). PID 1 is a reserved MPEG PID. This table lists, for each program or service, the PID number of the packet(s) that contain the EMM message(s). In the preferred embodiment, the EMM message with encrypted session key is sent on demand only to the STBs that requested them via MPEG packets bearing the DOCSIS PID, and no CAT table is used.

In the example of FIG. 12, a CAT table is used, and CAT table block 218 contains the reference to the PID of the packet 214 that contains the EMM message with an encrypted session key for program 3.

Step 256 represents the process of generating the appropriate filter commands. In other words, in step 256, the microprocessor 128 uses the information in PMT block 194 (and data in the CAT table in some embodiments) to generate filter commands to cause the TS demultiplexer 136 to filter out all the packets of the requested service, including the conditional access data, from the transport stream.

Step 258 represents the process of recovering the service data from the MPEG packets extracted in step 256. Specifically, the MAC frames in the MPEG packets containing the encrypted video, audio, supplemental data, PCR data and ECM message data. The MAC addresses in the MAC frames recovered from the MPEG frames are used to discard MAC frames not directed to this STB in step 258. Step 258 also represents the process of recovering the IP packets (or other packet or cell type—hereafter all referred to as an IP packet) encapsulated in the MAC frames, and using the addresses in the IP packets to route the data contained in the IP packet payloads (other packets that are addressable can also be used) to the appropriate circuitry in the STB for further processing. The encrypted ECM messages are routed to a process which will decrypt the ECM messages using the session key to recover the service key and send the service key to the conditional access decryption engine. The encrypted video packets (and possibly audio packets) are routed to the conditional access decryption engine for decryption using the service key to decrypt the video payloads.

Step 260 represents the process of recovering the EMM message for the requested service. In some embodiments, this is done by generating the appropriate filter commands to to extract the MPEG packets having the DOCSIS PID. The MAC frames in the extracted DOCSIS PID MPEG packets are recovered, and all MAC frames not addressed to this STB are rejected. In embodiments using a CAT table, this is done by generating filter commands to extract MPEG packets having PID 1. The MAC frames therein are recovered, and the IP packets therein are routed to a CAT table reconstruction process where the CAT table is reconstructed. The CAT table is searched using the requested service identifier and the PIDs of the MPEG packets containing the EMM messages is found. The microprocessor then generates filter commands to extract these MPEG packets containing the EMM message. The MAC frames in these packets are recovered.

Step 262 represents the process of recovering the IP packets from the MAC frames recovered in step 260 which bear the EMM message. The IP port addresses in these IP packets are used to route the EMM messages. The IP packets bearing the EMM message are addressed to the port of the EMM message decryption process. Step 262 also represents the process of recovering MPEG packets having the DOCSIS PID which carry other M&C data. The MAC frames therein are recovered, and the encapsulated IP frames are recovered. The M&C data in these IP packets is then routed to the processes identified in the port identifiers of the IP packets for further processing.

In step 264, the encrypted EMM messages containing the session key is decrypted using the private user key of the STB. Typically, a secure microprocessor on a smart card will be used to use the private user key of the STB to decrypt the EMM message to recover the session key and then use the session key to decrypt the ECM message to recover the service key or control word(s). In alternative embodiments, the general purpose microprocessor 128 can be used to do these functions.

In step 266, the microprocessor sends the recovered session key to another process which decrypts the service key or control word in the ECM message using the session key.

In step 268, the control word or service key is sent to the conditional access decryption engine 150 (which has also received the encrypted video packet data (and/or any other encrypted data of the service). There, the service key is used to decrypt the payloads of the video or other encrypted data packets of the program or service.

In step 270, the other management and control data sent to the STB on MPEG packets containing the DOCSIS PID is used in other circuits of the STB to control functions of the STB, display program guide data, load application software, manage the STB, etc.

The EMMs containing the sessions keys to decrypt the ECMs are put into multiple EMM messages, each encrypted by the secret user key of one STB. Each STB receives all the EMMs in some embodiments, and decrypts the one encrypted with its private user key using the private user key of the STB. In other embodiments, the EMMs are sent only to the STB whose private user key was used to encrypt it.

Preferred Conditional Access Method

In the preferred embodiment, the ECMs with service keys are changed frequently and sent as part of the MPEG-2 transport stream as an attribute of the encrypted video. The EMMs with the session keys howevever are sent only upon demand from a STB, and are sent only to the STB which requested it via the DOCSIS PID. In this preferred embodiment of the invention, we are sending the EMM messages in-band on the DOCSIS PID and only on an as-requested basis to the STBs that requested them and we are eliminating the CAT table.

The conditional access circuits in FIGS. 8-11 can implement any one of these alternative embodiments. The user key used to decrypt the EMM messages can be maintained by the microprocessor 128 in FIGS. 8-11 or it can be kept in the conditional access circuit with the filter instructions controlling the transport stream demultiplexer to extract ECM and EMM messages as well as the packets containing the desired program or service from the transport stream and send all these packets to the conditional access circuit.

Referring to FIG. 13, there is shown a flow diagram of the general process of receiving upstream requests for management and control data and responding by sending the requested management and control data downstream on the DOCSIS PID. Step 222 represents the process of receiving one or more upstream requests on a pure DOCSIS channel requesting that one or more items of management and control data in support of a digital broadcast, interactive service or video-on-demand request be sent downstream to a specific STB. Those items can be application software, program guide data, etc. Step 224 represents the process of generating or fetching the requested management and control data and addressing it to the STB that requested the data and packetizing the requested management and control data and any other management and control data to be broadcast to all STB into one or more MPEG-2 packets having a DOCSIS PID. Typically, the fetched or generated data will be encapsulated in an IP packet or other packet type which can be addressed to the STB that requested the data and then the IP packet will be encapsulated into a MAC frame and the MAC frame encapsulated into MPEG-2 packets. Step 226 represents the process of merging the MPEG-2 packets bearing the management and control data and having the DOCSIS PID with the MPEG-2 packets of one or more MPEG transport streams carrying the digital video broadcasts, interactive services or video-on-demand data to form a single MPEG-2 transport stream or multiplex of transport streams.

DOCSIS M&C Channel Bandwidth Considerations and Load Balancing

When the number of users on a downstream reaches a high level, there is the possibility that the M&C downstream channel will become overloaded. Any conventional load balancing scheme to shift traffic from a downstream onto another downstream implemented as an MPEG-2 transport stream with a M&C channel on the DOCSIS PID will suffice to implement the load balancing aspects of the invention. To alleviate congesion on the DOCSIS PID, programs or services that are generating M&C traffic are shifted to another MPEG transport stream in the same multiplex or another multiplex on a different downstream channel frequency (referred to in the claims as “another MPEG multiplex stream). In such a case, any M&C messages pertaining to the shifted programs and already in the downstream queue of the downstream from which they came will be lost. These M&C messages and any other M&C messages pertaining to the programs or services shifted to the other MPEG transport stream will be re-transmitted or, in the case of new M&C messages, transmitted in MPEG packets having the DOCSIS PID included in the other MPEG transport stream. This relieves congesion on the DOCSIS PID in the original transport stream. In the case of lost M&C messages, the upper IP reliability layers will have to deal with retransmitting these M&C messages on the new DOCSIS PID downstream. The head end will also have to send messages to the STBs that requested the shifted services or which are tuned to the digital broadcasts that have been shifted telling the STBs to which new downstream to tune to obtain the requested services or broadcasts.

This shifting of programs or services for load balancing can be triggered in any of a number of different ways. The CMTS knows which STBs have ordered services. The CMTS, in one embodiment, can simply make assumptions based upon the number and type of services being delivered on an MPEG transport stream that the M&C data on the DOCSIS PID of that transport stream is too high when a predetermined threshold of programs and services has been ordered. This trigger point can be based also on the types of services ordered and can be lower when services having larger amounts of M&C traffic such as software downloads and program guide data have been ordered. A look up table having different threshold numbers for starting load balancing shifts for different numbers of various types of programs or services could be used so that a lower number of programs or services with high M&C traffic would cause load shifting that for other programs or services having lower amounts of M&C traffic.

Another way of monitoring the load on the DOCSIS PID is to have the STBs start a hardware or software timer when they make an upstream request and stop the timer when the request is honored and the service is delivered. The elapsed time is stored and sent in an upstream message to the CMTS spontaneously or when the CMTS polls the STB for that type of data. The CMTS assumes the load on the DOCSIS M&C downstream channel is too high when the elapsed times exceed some predetermined threshold.

Head End IP Switching/Routing

One of the disadvantages of using the MPEG transport protocol to deliver interactive services and video-on-demand or other digital service data targeted to specific STBs is that MPEG is not as a wide area network protocol for a switched environment since it does not include any connection management or any connectionless routing mechanisms. This problem is solved by the headend architecture of FIG. 16. A video-on-demand server 235 outputs an MPEG transport stream of VOD movies in MPEG packets encapsulated in IP packets on line 237. An interactive services server 259 outputs on line 261 an MPEG transport stream of interactive service data in MPEG packets encapsulated in IP packets. These IP packets are addressed to the devices or processes in the STBs or connected to the STBs by buses or LANs that ordered the services. One or more servers represented by block 263 on the internet and/or at the headend provide services such as email or web pages etc. in IP packets on line 265. These IP packets are concentrated in an optional aggregator 267 at the head end and supplied to an IP switched network 269 (the IP cloud) at the head end which includes routers and switches which route IP packets to their various destinations. In alternative embodiments, the aggregator 267 is eliminated, and the IP cloud 269 is any collection of routers and switches located anywhere, and the servers 235, 259 and 263 supply their IP packets directly to switches or routers in the IP cloud network 269. A CMTS 271 supplies downstream DOCSIS. MPEG packets encapsulated in IP packets on line 273 (DOCSIS data packets) to the IP cloud 269. These downstream DOCSIS data packets include M&C data. These DOCSIS data packets are addressed to various devices and processes in or attached to the various STBs in three HFC systems the downstream media of each being represented by lines 275, 277 and 279, respectively.

The upstream media of each of these three HFC systems is represented collectively by line 281 coupled to the CMTS 271. Upstream IP packets from the various devices coupled to the three HFC systems arrive as DOCSIS data symbols on the three upstreams represented by line 281. The CMTS does conventional DOCSIS upstream processing to recover the MPEG packets encoded in said symbols and to recover MAC frames encapsulated in the MPEG packets. The CMTS also does conventional processing to recover IP packets encapsulated in the MAC frames. These IP packets are sent via line 291 to a router 285. The upstream IP packets are then routed over various data pathways, represented collectively by line 287, to the various servers to which they are addressed, including servers 235, 259 and 263.

The IP packets from servers 235, 259 and 263 which are addressed to devices on one of the three HFC networks are routed by the IP cloud router(s) to an IP switch/router 293 (which may be considered part of the IP switched network or cloud 269) which has output data paths coupled indirectly to each of the three HFC systems. There, IP packets addressed to devices and processes on HFC #1 are output on line 295 to circuitry to be described below and represented by block 297 for further processing and transmission downstream on HFC #1. The IP packets addressed to devices and processes on HFC #2 are routed on line 298 to circuitry represented by block 300 for processing and transmission downstream on HFC #2. The IP packets addressed to devices and processes on HFC #3 are routed on line 302 to circuitry represented by block 304 for processing and transmission downstream on HFC #2. The circuitry inside block 304 is the same type of circuitry as is included within blocks 300 and 297. This circuitry includes an IP stripper and dejitter and re-timing circuit 306. This circuit 306 strips off the IP headers and removes any jitter caused by encapsulating the MPEG transport stream packets in IP packets. This circuit also retimes the MPEG transport stream by adjusting the timestamps to account for different delays caused by the IP packetization process of video versus audio data MPEG packets so that the video and audio of a program will remain in synchronization.

The IP stripper has an output 308 for MPEG packets having the DOCSIS PID (which can skip the dejitter and retiming processes) and an output 310 at which MPEG packets of the VOD, interactive and other services are output. An MPEG multiplexer 312 assembles the MPEG packets on lines 308 and 310 into an MPEG multiplex on line 314. A quadrature amplitude modulator 316 breaks the MPEG packets in the multiplex into symbols and quadrature amplitude modulates two radio frequency carries having the same frequency but 90 degrees out of phase using some of the bits of each symbol to amplitude modulate one RF carrier and the other bits of each symbol to amplitude modulate the other carrier. In some embodiments, carrierless modulation using Hilbert transforms is used as is well known in the art.

The structure of FIG. 16 solves the problem found in the Pegasus prior art of the MPEG transport mechanisms not being well suited for use in switched wide are networks by basically encapsulating the MPEG packets in IP packets with the proper addresses, routing the IP addresses and then stripping off the IP headers and transmitting the original MPEG packets on the HFC systems.

### SUMMARY OF ADVANTAGES

In summary, the advantages of using a DOCSIS M&C channel within an MPEG-2 multiplex delivering interactive and VOD and digital broadcast services are:

(1) DOCSIS is a proven technology with exising hardware and software to implement already designed and built;

(2) a thin DOCSIS channel allows network management without an OOB channel and allows STBs to be less complex and more inexpensive and allows them to be managed from the head end;

(3) subscriber management by on-demand download of conditional access data via the thin DOCSIS channel for one way key transmission downstream only to secure the downstream MPEG-2 multiplex programs from unauthorized viewing or access (alternatively, the DOCSIS key exchange protocol can be used to render both the downstream and upstream DOCSIS channels secure and to protect the downstream MPEG-2 multiplex programs from unauthorized viewing or access);

(4) secure software application download of only the applications needed to only the STBs that need it—this simplifies the STBs and makes them less expensive to build and it allows bug fixes and upgrades from the head end and it future proofs the STBs;

(5) the bidirectional nature of the thin DOCSIS channel allows interactive and on-demand services to be implemented, and they can be implemented in a more secure way since the DOCSIS key exchange protocol authenticates the source of a request for an interactive or VOD service;

(6) a thin DOCSIS channel allows event provisioning by allowing collection of requests from the STBs for pay-per-view events and sending of conditional access keys to decrypt the pay-per-view event MPEG packets transmitted in the MPEG-2 multiplex;

(7) on demand delivery of only the program guide data needed to only the STB that requested it can be done over the thin DOCSIS channel thereby preventing the waste of bandwidth of data carousels in either OOB or in-band channels; and

(8) a thin DOCSIS channel also allows emergency alert system data to be transmitted in an MPEG-2 multiplex.

Although the invention has been disclosed in terms of the preferred and alternative embodiments disclosed herein, those skilled in the art will appreciate possible alternative embodiments and other modifications to the teachings disclosed herein which do not depart from the spirit and scope of the invention. All such alternative embodiments and other modifications are intended to be included within the scope of the claims appended hereto.

What is claimed is:

1. A process of transmitting management and control data to set top boxes in a cable television system providing digital broadcast, digital interactive services and digital video on demand services, comprising the steps:
1) receiving upstream management and control messages on a conventional DOCSIS upstream requesting downstream management and control (M&C) data;
2) generating downstream M&C packets by generating and/or fetching the requested M&C data, addressing said M&C data to the set top box (STB) that requested said M&C data, and packetizing the addressed downstream M&C data in one or more MPEG packets, each having a DOCSIS PID;
3) merging the downstream M&C packets into an MPEG transport stream or MPEG multiplex containing multiple MPEG transport streams.

2. The process of claim 1 wherein step 1 further comprises the step of receiving upstream requests for broadband internet access data or data of any other digital service, and wherein step 2 further comprises the steps of:
fetching the requested broadband internet access data or data of the requested other digital service as internet protocol (IP packets);
encapsulating said broadband internet access data IP packets into an media access control (MAC) frames addressed to the STB that requested the data; and
encapsulating said MAC frames into an MPEG-2 packets having the DOCSIS PID and merging said MPEG-2 packets having the DOCSIS PID into said MPEG transport stream or multiplex;
and wherein step 2 comprises encapsulating said M&C data packets into IP packets addressed to the ports in said set top boxes running processes which requested or need said M&C data, and encapsulating said IP packets into MAC frames addressed to the set top boxes which requested or need the M&C data.

3. The process of claim 1 wherein step 2 comprises fetching and/or generating only the requested management and control data and packetizing the requested management and control data in Internet Protocol packets (IP packets) addressed to the STB which requested said management and control data or using a multicast address in said IP packets which includes all the STBs which requested said management and control data.

4. A process for transmitting management and control data downstream in-band on a digital data delivery network transmitting interactive services downstream on an MPEG transport stream, comprising the steps:
(1) generating and/or retrieving management and control data (said M&C data) pertinent to one or more services to be provided to or requested by one or more subscribers, said M&C data to be sent to one or more set top receiver/decoder circuits (hereafter set top boxes);
(2) packetizing said management and control data in MPEG packets having a DOCSIS program identifier (PID);
(3) packetizing into MPEG packets data of one or more services which can include interactive services, video-on-demand, digital video broadcasts and/or any other type of service provided via digital data and giving MPEG packets of each said service one or more unique PIDs; and
(4) merging said MPEG packets having said DOCSIS PID with MPEG packets of said one or more services into an MPEG transport stream or an MPEG multiplex of more than one MPEG transport streams and transmitting said transport stream or multiplex downstream on a data delivery network to a plurality of subscribers.

5. The process of claim 6 further comprising the step of receiving upstream requests from one or more set top boxes of one or more subscribers for program guide data, software application programs, conditional access key data or any other management and control data, and responding thereto by performing step (1) by generating and/or retrieving management and control data which responds to said received upstream requests and packetizing said management and control data into packets each addressed to the specific set top box that requested M&C data encapsulated in said packet.

6. The process of claim 5 wherein said step of receiving upstream requests from one or more set top boxes is comprised of receiving said upstream requests as data on a DOCSIS upstream which is linked in the DOCSIS messaging protocol to the DOCSIS downstream comprised of said MPEG packets having said DOCSIS PID.

7. The process of claim 6 wherein said step of receiving upstream requests is carried out using normal DOCSIS protocols.

8. The process of claim 7 wherein said normal DOCSIS protocols comprise, at each set top box, at least the steps of:
(1) locking onto the DOCSIS downstream transmitted on said DOCSIS PID and searching downstream DOCSIS messages for a MAP message identifying an initial upstream station maintenance interval and receiving a downstream UCD message defining the characteristics of said DOCSIS upstream;
(2) performing DOCSIS ranging and training during said initial station maintenance intervals;
(3) receiving a ranging response message addressed to said set top box which transmitted said ranging burst, and adjusting transmit parameters in an upstream DOCSIs transmitter of said set top box in accordance with offset data in said ranging response message;
(4) waiting for a message transmitted via the downstream DOCSIS PID containing an invitation to do period ranging and training in a subsequent periodic station maintenance interval and sending a periodic station maintenance burst and receiving a ranging response message in response thereto and using offset data therein to update upstream DOCSIS transmit parameters of said set top box;
(5) after ranging and training has been successful, sending an upstream message during a bandwidth request contention interval and scanning received downstream MAP messages to determine if said bandwidth request has been successfully received and upstream bandwidth awarded, and, if not, retransmitting the request during subsequent bandwidth request contention intervals;
(6) if upstream bandwidth has been awarded, transmitting upstream management and control messages from each set top box during the upstream minislots assigned to said set top box using upstream channel parameters as defined in said UCD message which defined said upstream DOCSIS channel.

9. The process of claim 4 further comprising the steps:
(1) generating any management data needed to remotely manage one or more of said set top boxes from a cable modem termination system at the head end of a cable television system;
(2) packetizing said management data in packets addressed to the particular set top boxes to which the management data needs to be sent and packetizing said packets in MPEG packets having a DOCSIS program identifier (PID); and
(3) merging said MPEG packets having DOCSIS PIDs and containing management data into said MPEG transport stream or multiplex along with other MPEG packets having a DOCSIS PID and bearing M&C data.

10. A process for sending and receiving management and control data or other data in a set top box in a cable television system providing digital broadcast, digital interactive services and digital video on demand services, comprising the steps:
receiving at a set top receiver/decoder (hereafter STB) coupled to a cable television system transmission medium one or more user command(s) indicating the type of digital broadcast, interactive, video-on-demand service(s) and/or other service a user would like to utilize via a television or other peripheral device coupled to said STB;
transmitting upstream on a pure DOCSIS channel management and control (M&C) data which requests downstream transmission of M&C data which supports or enables utilization of the requested service(s);
in said STB which received said user command(s), recovering MPEG packets from a downstream MPEG transport stream or multiplex and extracting MPEG packets therefrom having a DOCSIS program identifier (PID) and carrying M&C data including conditional access data addressed to said STB and pertaining to said service(s) requested by said user, and routing said MPEG packets having a DOCSIS PID to a microprocessor programmed to control said STB, and extracting MPEG packets from said MPEG multiplex carrying data of said requested service(s) and routing encrypted MPEG packets to a conditional access circuit and routing non encrypted MPEG packets to a decoder if they are not encrypted;
decrypting said conditional access data to obtain one or more working key(s) needed by said conditional access circuit to decrypt the payloads of said encrypted MPEG packets containing data of said requested service(s);
using said working key(s) in said conditional access circuit to decrypt payload sections of said encrypted MPEG packets and decompressing the decrypted payload data to generate uncompressed data of one or more of the requested service(s);
decompressing said non encrypted MPEG packets to obtain non compressed data of one or more of the requested service(s) if any of the requested services are not encrypted;
using an encoder to encode said uncompressed data of the requested service(s) into a suitable television or other signal, data or packet in a suitable format for a television or any other peripheral device coupled to said STB.

11. A process for sending management and control data and conditional access data to a set top box, comprising:
(1) receiving at a cable modem termination system, upstream DOCSIS messages which indicate at least a service a set top receiver/decoder (hereafter set top box) has ordered;
(2) retrieving the data of said service and encapsulating it in media access control frames (MAC frames) addressed to the MAC address of said set top box which ordered said service and encapsulating said MAC frames in MPEG packets having PIDs which indicate to which service data in said MPEG packets pertains;
(3) retrieving or generating management and control data which said set top box needs including all management and control data and a session key said set top box needs to provide said service to a user;
(4) encrypting a control word for said service using said session key;
(5) encrypting said session key using a private user key of said set top box and encapsulating said encrypted session key in an EMM message and encapsulating said EMM message in an IP packet and encapsulating said IP packet in a MAC frame addressed to said MAC address of said set top box and encapsulating said MAC frame in an MPEG packet having the reserved DOCSIS PID of an MPEG transport stream;
(6) encapsulating all other management and control data retrieved or generated in step (3) in IP packets and encapsulating said IP packets in MAC frames addressed to said set top box, and encapsulating said MAC frames in MPEG packets having said reserved DOCSIS PID; and
(7) assembling all said MPEG packets containing the data of said service and said management and control data into one or more MPEG transport streams, and transmitting said one or more MPEG transport streams to said set top box.

12. The process of claim 11 wherein step (3) includes retrieving management and control data comprising one or more software applications needed by said set top box, authenticating said software applications using a DOCSIS secure software download protocol and sending said software application to said set top box for loading and execution.

13. A process for receiving encrypted service data at a set top receiver/decoder (set top box), comprising:
(1) receiving at a set top box a command to order a service, and using a transmitter section of a DOCSIS compatible cable modem to transmit one or more upstream DOCSIS messages ordering said service and indicating any other management and control data including any conditional access data needed by said set top box, and;
(2) using a receiver section of said DOCSIS compatible cable modem, receiving a downstream MPEG multiplex and extracting MPEG packets having PID 0 and constructing a program allocation table from data in said extracted packets;
(3) using data in said program allocation table to determine which MPEG transport streams are in said MPEG multiplex and which transport stream(s) carry the data of said requested service and to determine the PID of MPEG packets in said transport stream which carry data of a program map table(s) of said transport stream(s) which defines the PID(s) of MPEG packets in the service(s) ordered by said set top box;
(4) using a receiver section of said DOCSIS compatible cable modem extracting MPEG packets having said PID of said program map table, and constructing a program map table from data in said extracted packets;
(5) using data in said program map table to determine the PID numbers of MPEG packets in said MPEG multiplex containing the data of said service including PCR timing data and any necessary conditional access ECM messages and generating filter commands to extract from said MPEG multiplex MPEG packets having PIDs of said service(s) ordered by said set top box;
(6) MPEG packets containing management and control data and conditional access EMM messages and having a DOCSIS PID are extracted from said MPEG multiplex;
(7) MAC frames in said MPEG packets extracted in steps (5) and (6) are recovered and any MAC frames not addressed to said set top box which ordered said service(s) are discarded;
(8) IP packets carrying said service data, management and control data, EMM messages and ECM messages are extracted from said MAC frames not rejected in step (7) and are routed to the proper circuitry in said set top box or connected to said set top box by a bus or local area network connection;
(9) extracting encrypted session key(s) for said services said set top box ordered from IP packets containing EMM messages which have been routed to a secure microprocessor circuit having nonvolatile memory in said set top box or in a smart card or other module or circuit card inserted in said set top box, and decrypting said EMM message(s) using a private user key for said set top box stored in said nonvolatile memory so as to recover said session key(s);
(10) using said session key(s) to decrypt said ECM messages routed to said secure microprocessor so as to recover a control word for each said service ordered by said set top box;
(11) using said control word(s) to decrypt the payload data of packets containing said service data for said service(s) ordered by said set top box, decompressing any compressed data and generating suitable video or other format signals from said decrypted and decompressed data.

14. The process of claim 13 wherein step (11) includes the step of sending said decrypted, decompressed data of a service to a device coupled to said STB which requested said service.

15. A process for sending conditional access data in band, comprising:
(1) receiving upstream management and control (M&C) messages from one or more set top receiver/decoders (hereafter set top boxes or STBs) on a DOCSIS upstream channel requesting downstream transmission of conditional access key data in support of one or more requested services;
(2) retrieving or generating a session key for at least each encrypted service which has been ordered by an STB;
(3) encrypting a control word for each service ordered by an STB with a session key for said service, and encapsulating each said encrypted control word in an ECM message;
(4) encapsulating each said ECM message in an IP packet having a multicast address such that all STBs can receive said IP packet;
(5) encapsulate each said IP packet generated in step (4) in a media access control frame (MAC frame) having a multicast address;
(6) encapsulate each said MAC frame generated in step (5) in one or more MPEG packets having PID which indicates for each said MPEG packet that it contains an ECM message for a particular service;
(7) at the head end, encrypting each said session key for a service an STB has ordered with a private user key of said STB, and encapsulating said encrypted session key in an EMM message;
(8) encapsulating each said EMM message in an IP packet addressed to the STB that ordered said service to which the encapsulated EMM message pertains, or, if the STBs do not have IP addresses, encapsulating each said EMM message in an IP packet which has a multicast address;
(9) encapsulating each IP packet generated in step (8) containing an EMM message pertaining to a particular service in a MAC frame addressed to the MAC address of an STB which ordered said service, and encapsulating each said MAC frame in an MPEG packet having a predetermined PID, and encapsulating other management and control data in IP packets and encapsulating the IP packets in MAC frames addressed to the MAC address of the STB that needs said management and control data and encapsulating said MAC frames in MPEG packets having the DOCSIS PID;
(10) adding said MPEG packets generated in step 9 to an MPEG transport stream or multiplex of transport streams; and
(11) adjusting data in a program allocation table and one or more program map tables of said MPEG transport stream or multiplex of transport streams carrying data of one or more services to reflect the PIDs of MPEG packets containing data of each said service, PCR timing data for each said service, ECM packets for each said service, and adjusting data in a conditional access table to point to the PID of the EMM message for each service if said EMM message for said service is not sent in an MPEG packet having said DOCSIS PID but is sent in an MPEG packet having a PID which indicates said MPEG packet contains an EMM message for a particular service.

16. The process of claim 15 wherein step 9 comprises encapsulating each said IP packets containing an EMM message in a MAC frame addressed to a MAC address of the STB which ordered the service to which said EMM message pertains, and encapsulating each said MAC frame in an MPEG packet having a DOCSIS PID.

17. The process of claim 15 wherein step 9 comprises encapsulating each said IP packets containing an EMM message in a MAC frame addressed to a MAC address of the STB which ordered the service to which said EMM message pertains, and encapsulating each said MAC frame in an MPEG packet having a PID which indicates said MPEG packet contains an EMM message pertaining to a particular service having said PID assigned to EMM messages for said service.

18. A head end apparatus for transmitting management and control data on the DOCSIS PID of an MPEG multiplex and for transmitting service data on said MPEG multiplex, comprising:
an interactive service server programmed to receive requests for interactive and/or video-on-demand services and respond thereto by supplying an MPEG transport stream of MPEG packets containing the requested services and having one or more PIDs which define which packets contain data from which services;
a server programmed to supply management and control data in support of said interactive services;
a cable modem termination system programmed to receive said management and control data and to carry out DOSCIS processing to generate MPEG packets having a DOCSIS PID and having said management and control data encapsulated therein;
a computer executing a transport multiplexer process and programmed to receive said MPEG packets containing the requested services and said MPEG packets having said DOCSIS PID and for combining said MPEG packets into one or more MPEG transport streams comprising an MPEG multiplex;
and wherein said cable modem termination system is programmed to execute a DOCSIS physical media dependent layer process and receive said one or more MPEG transport streams and perform DOCSIS processing thereon to generate symbols for downstream transmission on a hybrid fiber coaxial cable system.

19. The head end apparatus of claim 18 further comprising a digital video broadcast server programmed to output an MPEG transport stream of MPEG packets containing data of regularly scheduled digital video broadcasts, and wherein said computer executing a transport multiplexer process is programmed to receive said MPEG transport stream from said digital video broadcast server and incorporates said transport stream with said MPEG transport stream output by said interactive service server and said MPEG packets having said DOCSIS PID into an MPEG multiplex.

20. The head end apparatus of claim 18 further comprising a digital video broadcast server programmed to output an MPEG transport stream of MPEG packets containing data of regularly scheduled digital video broadcasts, and one or more other service provider servers programmed to bidirectionally communicate data of other services with said cable modem termination system, and wherein said cable modem termination system is programmed to encapsulate downstream data of said other services in one or more IP packets addressed to the device(s) and/or process(es) which requested said service data and encapsulate said IP packets in one or more MAC frames addressed to the MAC address(es) of one or more set top boxes containing or connected to said device(s) and/or process(es) which requested said other service data, and encapsulate said MAC frames in MPEG packets having a DOCSIS PID, and wherein said computer executing a transport multiplexer process is programmed to receive said MPEG transport stream from said digital video broadcast server and incorporate said transport stream with said MPEG transport stream output by said interactive service server and said MPEG packets having said DOCSIS PID into an MPEG multiplex.

21. The apparatus of claim 18 wherein said cable modem termination system is programmed to receive IP packets from any source and use conventional DOCSIS processing as a transport mechanism to deliver said IP packets transparently to one or more set top boxes and/or devices coupled thereto via a hybrid fiber coaxial cable system.

22. The apparatus of claim 18 wherein said cable modem termination system is programmed to perform conventional DOCSIS processing including conventional DOCSIS processing to exchange messages with DOCSIS compatible cable modem circuitry in each set top box coupled to said hybrid fiber coaxial cable system to cause said DOCSIS compatible cable modem circuitry to perform ranging and training to establish a pure DOCSIS upstream channel, said normal DOCSIS processing including establishing bandwidth request contention intervals by transmission of downstream MAP messages in MPEG packets having said DOCSIS PID and reception of upstream bandwidth request messages from said set top boxes during said bandwidth request contention intervals and processing said bandwidth request messages to award upstream minislots to specific set top boxes for upstream transmissions and sending downstream MAP messages in MPEG packets having said DOCSIS PID which specify specific upstream minislots during which specific set top boxes may transmit, and wherein said DOCSIS processing includes receiving upstream DOCSIS messages transmitted from said set top boxes via said pure DOCSIS upstream channel and processing said DOCSIS messages to recover media access control frames encapsulated therein and IP packets encapsulated in said media access control frames and routing of said IP packets toward the devices or processes having the IP addresses specified in said IP packets.

23. The apparatus of claim 18 wherein said server programmed to supply management and control data supplies said data in IP packets, and wherein said cable modem termination system is programmed to receive said IP packets with management and control data therein and encapsulate said IP packets in DOCSIS media access control frames (MAC frames) addressed to MAC addresses of only the set top boxes which need said management and control data, and to encapsulate said MAC frames in MPEG packets having said DOCSIS PID.

24. The head end apparatus of claim 18 further comprising a digital video broadcast server programmed to output an MPEG transport stream of MPEG packets containing data of regularly scheduled digital video broadcasts, and one or more other service provider servers programmed to bidirectionally communicate data of other services with said cable modem termination system, and wherein said cable modem termination system is programmed to encapsulate downstream data of said other services in one or more IP packets addressed to the device(s) and/or process(es) which requested said service data and encapsulate said IP packets in one or more MAC frames addressed to the MAC address(es) of one or more set top boxes containing or connected to said device(s) and/or process(es) which requested said other service data, and encapsulate said MAC frames in MPEG packets having a private data PID, and wherein said computer executing a transport multiplexer process is programmed to receive said MPEG transport stream from said digital video broadcast server and incorporate said transport stream with said MPEG transport stream output by said interactive service server and said MPEG packets having said DOCSIS PID into an MPEG multiplex.

25. The head end apparatus of claim 18 wherein said cable modem termination system is further programmed to monitor in any way the traffic level of management and control data (M&C data) being sent downstream on the DOCSIS PID (M&C channel) and to use any conventional load balancing scheme to shift programs and/or services and associated management and control data some to another MPEG transport stream in said MPEG multiplex and put said associated management and control data in MPEG packets on said other MPEG transport stream having the DOCSIS PID.

26. The head end apparatus of claim 25 wherein said cable modem termination system is programmed to monitor load on said M&C channel by keeping records as to the number of services and/or programs of particular types that have been ordered by said set top boxes, and assume that the load on said M&C channel is too high when the number of programs and/or services meets or exceeds a predetermined threshold.

27. The head end apparatus of claim 25 wherein said cable modem termination system is programmed to monitor load on said M&C channel by keeping records as to the number and types of services and/or programs ordered and consulting a look up table having different threshold numbers for when load balancing shifting should start for various numbers of differents types of programs and services having been ordered.

28. The head end apparatus of claim 25 wherein said cable modem termination system is programmed to monitor load on said M&C channel by receiving messages from said set top boxes containing response time latencies indicating the amount of time said set top boxes had to wait before upstream requests for programs and/or services were honored and making a determination that load balancing shifting or programs and/or services to another MPEG transport stream should start when latencies become too long.

29. A head end apparatus for transmitting MPEG packets bearing video-on-demand and/or interactive service data and/or other service data and management and control data to specific set top receiver/decoders (set top boxes) coupled to a plurality of data distribution channels which convey data from a head end to said set top boxes, comprising:
one or more servers programmed to receive requests for services and respond by outputting IP packets bearing data of said requested services or MPEG packets in a transport stream which are encapsulated in IP packets, all said IP packets being addressed to devices or processes in or coupled to said set top boxes;
an IP switching network comprised of one or more routers and/or switches coupled to receive said IP packets from said one or more servers and other sources and programmed to route each said IP packet to one or more different outputs of said routers and/or switches according to addressing information in said IP packet;
a cable modem termination system coupled to receive DOCSIS upstreams from each of said plurality of data distribution channels and programmed to extract management and control messages including requests for services and send said management and control data including said requests to a router for routing to servers needing said management and control data and requests, said cable modem termination system also programmed to generate and output to said IP switching network downstream DOCSIS messages encapsulated in MPEG packets which are encapsulatated in IP packets, said DOCSIS messages including messages containing managment and control data, said IP packets addressed to devices and/or processes in set top boxes or coupled thereto which need management and control data;
on each output of said IP switching network coupled to one of said plurality of data distribution channels, a circuit coupling said output to said data distribution channel, said circuit comprising:
an IP stripper, de-jitter and retiming circuit which functions to strip IP packet headers from said IP packets appearing at said output and route encapsulated MPEG packets having a DOCSIS PID to a first output and route encapsulated MPEG packets having PIDs of service data provided by said one or more servers to a de-jitter and re-timing process where jitter caused by the encapsulating of said MPEG packets in IP packets is removed to recover the original MPEG transport stream and wherein timestamp data in said MPEG transport stream is adjusted to synchronize audio data with video data, and functioning to output MPEG packets which have been de-jittered and re-timed at a second output;
an MPEG multiplexer coupled to said first and second outputs for combining MPEG packets appearing at said first and second outputs into an MPEG transport stream or an MPEG multiplex comprised of a plurality of MPEG transport streams; and
a quadrature amplitude modulator coupled to receive said MPEG transport stream or MPEG multiplex and functioning to generate therefrom a quadrature amplitude modulated radio frequency signal.
